(19) United States
(12) Patent Application Publication
(10) Pub. No.: US 2015/0112682 A1
(43) Pub. Date: Apr. 23, 2015

(54) METHOD FOR VERIFYING THE IDENTITY OF A SPEAKER AND RELATED COMPUTER READABLE MEDIUM AND COMPUTER

(71) Applicant: Agnitio SL, Madrid (ES)

(72) Inventors: Luis Buera Rodriguez, Madrid (ES); Marta Garcia Gomar, Madrid (ES); Marta Sanchez Asenjo, Madrid (ES); Alberto Martin de los Santos de las Heras, Madrid (ES); Alfredo Gutierrez, Madrid (ES); Carlos Vaquero Aviles-Casco, Madrid (ES); Alfonso Ortega Gimenez, Madrid (ES)

(21) Appl. No.: 14/589,969

(22) Filed: Jan. 5, 2015

Related U.S. Application Data
(63) Continuation-in-part of application No. 12/998,870, filed on Jun. 10, 2011, now Pat. No. 8,762,149.
Application No. 12/998,870 is a continuation-in-part of application No. 14/495,391, filed on Sep. 24, 2014.
Application No. 14/495,391 is a continuation-in-part of application No. 14/083,942, filed on Nov. 19, 2013, now abandoned.

(51) Int. Cl. G10L 15/00

(52) U.S. Cl. CPC G10L 15/00
USPC 704/249; 704/246

(57) ABSTRACT

The present invention refers to a method for verifying the identity of a speaker based on the speaker's voice comprising the steps of: a) receiving a voice utterance; b) using biometric voice data to verify that the speakers voice corresponds to the speaker the identity of which is to be verified based on the received voice utterance; and c) verifying that the received voice utterance is not falsified, preferably after having verified the speakers voice; d) accepting the speaker's identity to be verified in case that both verification steps give a positive result and not accepting the speaker's identity to be verified if any of the verification steps give a negative result. The invention further refers to a corresponding computer readable medium and a computer.

### CROSS-REFERENCE TO RELATED APPLICATIONS

This application is a continuation-in-part of U.S. patent application Ser. No. 12/998,870 titled “METHOD FOR VERIFYING THE IDENTITY OF A SPEAKER AND RELATED COMPUTER READABLE MEDIUM AND COMPUTER”, filed on Jun. 10, 2011, which claims priority to PCT application PCT/EP2008/010478, titled “METHOD FOR VERIFYING THE IDENTITY OF A SPEAKER AND RELATED COMPUTER READABLE MEDIUM AND COMPUTER”, filed on Dec. 10, 2008, the entire specifications of each of which are hereby incorporated by reference in their entirety. This application is also a continuation-in-part of U.S. patent application Ser. No. 14/495,391 titled “ANTI SPOOFING”, filed on Sep. 24, 2014, which is a continuation-in-part of U.S. patent application Ser. No. 14/083,942 titled “ANTI SPOOFING”, filed on Nov. 19, 2013, the entire specifications of each of which are hereby incorporated by reference in their entirety.

### BACKGROUND OF THE INVENTION

1. Field of the Invention

The present application refers to a method for verifying the identity of a speaker based on the speaker's voice.

2. Discussion of the State of the Art

Verification of the identity of the speaker is used, for example, for accessing online banking systems or any other system where the identity of the speaker needs to be verified. The verification of the identity of the speaker refers to the situation where someone pretends to have a certain identity, and it needs to be checked that the person indeed has this identity.

Identification of the speaker based on the speaker's voice has particular advantages since biometric voice data can be extracted from a speaker's voice with such a degree of accuracy that it is practically impossible by any other speaker to imitate another person's voice with a sufficient degree of accuracy in order to perform fraud.

### SUMMARY OF THE INVENTION

The object of the present invention is to provide a method and an apparatus, which further increases security of the verification of the identity of a speaker.

According to the method for verifying the identity of a speaker, first a voice utterance is received. This voice utterance is analyzed using biometric voice data to verify that the speaker's voice corresponds to the identity of the speaker that is to be verified. Further one or more steps are performed wherein it is verified that the received voice utterance is not falsified. It may be thought of that the voice utterance may be falsified in the respect that the voice utterance of the identity of the speaker which needs to be verified is recorded and afterwards rendered. This may be done in order to pretend to have a certain identity e.g. to gain access to a system, which is protected by the identity verification. In such a case, the biometric voice data test will positively confirm identity because the voice fits with the pretended identity. Access or any other right, however, shall be denied since it is not the correct person that tries to gain access to a system.

Before the reception of the voice utterance such a voice utterance may be requested within the method. A speaker may for example be requested to pronounce a certain word, number, or sentence provided to him within the execution of the method (in the same session), or indicate a password or pass sentence agreed with him beforehand (i.e. before execution of the method).

In order to check the identity of a speaker very elaborated and detailed tests can be carried out which, however, lead to people getting annoyed by extensive and long verification procedures when for example trying to access a system or grant any other right. Such annoying identity verification methods are not practical and, therefore, a way has to be found which, on one hand is convenient for speakers the identity of which needs to be verified, and on the other hand prevents fraud of the identity verification.

The method refers to the step of determining whether the voice utterance is falsified. In those kinds of verifications, it is not determined that the voice is falsified (e.g. by a voice imitator), but whether the voice utterance based on an authentic voice is falsified. A falsified voice utterance in general may be any voice utterance which is not produced in the moment of the identity verification by the person to which the voice belongs but may be for example an utterance which was (e.g. secretly) recorded beforehand and is replayed afterwards for identity verification. Such recording may be done e.g. with a microphone positioned at a certain distance from the speaker (e.g. in the far field, such as more than 10 or 5 centimeter away) or may be located very close to the speaker e.g. in a telephone (typically less than 10 or 5 cm).

Further a falsified voice utterance may be an utterance composed of a plurality of (short) utterances which are composed to a larger utterance, thereby obtaining semantic content which was never recorded. If, for example during recording of a person's voice different numbers or digits are pronounced in a certain order voice utterances corresponding to each digit may be composed in a different order, such that any combination of numbers can be produced which may be requested by the verification system. While in those cases the voice is correct the voice utterance is falsified.

Another possibility of falsification of a voice utterance may be in the case of a synthetically generated voice. A voice generator may be trained or adjusted to imitate a particular kind of voice, such that with such a voice generator a voice utterance may be falsified.

A further option which can be thought of as a way of falsifying a voice utterance may be the case in which a voice utterance stored in a computer system is stolen. A stored voice utterance received e.g. for training or during a previous session may be stored in a computing system, e.g. one used for verifying the identity of a speaker as disclosed herein. If such a voice utterance is stolen, it may be replayed, thereby generating a falsified voice utterance.

In order to have the system as convenient as possible for the speakers, it is preferred that the verification that the voice utterance is not falsified is performed only after the speaker's voice has been verified.

Certain tests such as e.g. a passive test for verifying that the voice utterance is not falsified can, however, also be carried out in parallel once a voice utterance is received for verification of the speaker's identity.

In the method, lastly, a step is performed that either accepts a speaker's identity to be verified or does not accept the speaker's identity to be verified. If it can be verified that the speaker's voice corresponds to the speaker, the identity of which is to be verified, and that the voice utterance is not falsified, then the speaker's identity can be accepted to be verified. In this case, for example, access to a protected system may be granted and otherwise denied or further steps can be carried out in order to determine whether indeed the voice utterance is not falsified.

In a preferred embodiment, the received voice utterance is processed in order to determine whether or not it is falsified without processing any other voice utterance. The verification is, therefore, based on the one voice utterance which can be checked for hints that the voice utterance is falsified. In other steps of the verification that the received voice utterance is not falsified, however, other voice utterances may be processed before or after this sub step in which only the received voice utterance is processed.

The specified sub-step refers to the processing without any other voice utterance only up to having come to a previous conclusion whether or not the received voice utterance is falsified. This does not yet need to be the final conclusion thereon.

This kind of check can be part of a passive test for falsification since it does not require any additional input of a speaker during the identity verification session.

In a preferred embodiment any test whether or not the voice utterance is falsified is initially only a passive test, i.e. one that does not require a speaker to provide any additional voice utterance. In case that in this passive test no indication of a falsification is found the speaker is accepted. This is in particular useful for having a method that is convenient for the large number of speakers with no intention of fraud. This, however, requires, that the passive test is capable of detecting many kinds of hints, that the voice utterance may be falsified. The passive test therefore in a further preferred embodiment is able to detect different kind of hints that a voice utterance may be falsified.

According to a particular embodiment an active test for falsification which requires additional speaker input, is only carried out in case that the passive test for falsification has given an indication that the voice utterance may be falsified.

In the following some possible checks of a passive test for falsification are explained.

In a check being part of a passive test the recording of the voice in the far field may be detected by determining a speech modulation index from the voice utterance. Thereby additional noise or convolution noise can be identified which can be a hint for recording of the voice utterance in the far field (more than 5 or 10 cm away from the speakers mouth). Further a ratio of signal intensity in two frequency bands one having a lower frequency range than the other can be taken into account for detecting a far field recording. It has been found out that such a ratio provides a helpful indicator of a far field recording since the lower frequency components are usually more enhanced in the far field than in the near field. In a preferred embodiment a combination of the speech modulation index and of a low frequency/high frequency ratio can be used to identify falsifications.

In another check being part of a passive test the prosody may be evaluated in order to check e.g. whether the pronunciation of a word corresponds to its position in a phrase. It can be checked for example whether a word that is at the beginning or end of a sentence is pronounced in such a way. In natural speaking the pronunciation of one and the same word at the beginning, the middle and the end of a sentence is slightly different. These particular pronunciations can be checked by evaluating the prosody. Thereby it is possible to identify e.g. a synthetic voice generator, which usually are not able to provide a natural prosody and on the other hand it may be possible to detect an edited voice utterance wherein smaller pieces of voice utterances are composed to a larger voice utterance.

Further in a check being part of a passive test a voice utterance may be investigated for a certain acoustic watermark. Voice utterances that are stored in a computer system may be provided with acoustic watermarks. Thereby it can be assured that stolen voice utterances can be identified, when trying to identify such acoustic watermarks. An acoustic watermark, may be e.g. a particular signal at a specific frequency or (small) frequency range which does not disturb during replay but which can be identified e.g. by a Fourier analysis providing the particular signal in the specific frequency or frequency range.

Another possible check in a passive test is a check for discontinuities in the background noise. Here for example a background noise profile may be calculated for different time intervals such as e.g. time intervals of 1 to 5 or 2 to 3 seconds and the background noise profile of different time intervals may be compared. If there are major differences this can be an indication of e.g. an edited voice utterance or a far field recording in an ambient with much or changing background noise.

The result of the different checks of a passive test can be combined in different ways. They may for example be combined logically with AND and/or OR operations. Since the different checks usually identify different kinds of falsification they are preferably combined such that if any check indicates that a falsification may be given, the speaker is not accepted directly without prior tests or is not accepted at all.

In a further preferred embodiment a second voice utterance is requested and received. This corresponds to an active test for falsification. The request may be done by any suitable means such as, e.g., a telephone connection by which the first voice utterance was received. The request preferably requests a speaker to repeat the voice utterance received just beforehand. After receiving the second voice utterance, the first voice utterance and the second voice utterance are processed in order to determine an exact match of the two voice utterances. In case that, for example, a voice utterance is falsified by replaying a recorded voice utterance those two voice utterances will match exactly in certain aspects. The exact match of two voice utterances can be determined based on voice utterance specific parameters such as a GMM or any other frequency characteristic which are extracted from each of the voice utterances.

It has been found out that if one and the same person repeats the same text, minor variations are common. This may be due to slightly different pronunciations or due to a distinct background noise. If the voice utterance, however, is replayed from a recorded voice utterance those things do not vary, and hence, trying to determine an exact match is a useful means for identifying that a voice utterance is replayed and indeed is a previously recorded voice utterance.

For the above-mentioned test for an exact match it is, therefore, advantageous that the semantic content of the requested second voice utterance is identical to that of the received voice utterance. The semantic content may, however, be different and only a part of the semantic content is identical and the exact match is determined only for that part.

In the determination of an exact match it is also possible to compare a received voice utterance with a voice utterance that was received during a registration or training phase with that speaker, i.e. before the reception of the voice utterance for the identity verification.

If any other person secretly recorded such a voice utterance in order to replay it later on this will be detected. Equally the determination of an exact match may be done with respect to a voice utterance received beforehand in another session of identity verification, but after registration or training, such as e.g. a session in which the identity was verified a few days ago. Such a test for an exact match with a voice utterance received in a previous identity verification session or with a voice utterance received during registration or training may be done also as part of the passive test for falsification mentioned above and below.

In any above or below mentioned test for an exact match it may also be determined that the two voice utterances which are compared, do have at least some degree of similarity in order to avoid a result of a test of an exact match where two voice utterances are completely different already in their semantic content. The degree of similarity can be determined from characteristics extracted from two voice utterances.

In a possible scenario of fraud it may be tried to synthetically change the second voice utterance, such that it is not exactly equal to the first voice utterance. Such changes may be done for example with addition of white noise. Another possibility is to stretch or compress certain parts of the voice utterance thereby imitating a different prosody. When testing for an exact match different checks for identifying an exact match may be performed. One of those checks may be for example able to ignore any added white noise, while a second check may not be affected by stretching or compressing the voice utterance. The results of the different checks for an exact match are preferably logically combined e.g. by an OR operation such that any check that indicates an exact match leads to the final conclusion of the test of an exact match.

Further a test for an exact match is preferably combined with an additional test for verification of the speaker based on the second voice utterance. In case that the second voice utterance is synthetically altered the test for the speaker verification may fail since the alterations are too strong. Hence the combination of a speaker verification and a test for an exact match complement each other in an advantageous way to identify falsified utterances.

In another preferred embodiment the received voice utterance and the second received voice utterance are processed in order to determine an exact match of the two voice utterances or a portion thereof, respectively, and the second voice utterance is additionally processed by a passive test such as in a particular sub-step without processing any other voice utterance or data determined thereof, in order to verify that the second voice utterance is not falsified. Those two processing steps are carried out independently of each other and/or in parallel to each other. This increases processing speed, and therefore, convenience and also accuracy of the verification method since the results of the two tests can be logically combined in order to determine whether or not the voice utterances are falsified. Depending on the result of the two tests, different actions can be taken such as acceptance, rejection or further processing steps.

In a particular advantageous method it is attempted to check for veliness of the speaker (which is an example of an active test for falsification). Such a test provides for a highly reliable determination whether or not a received voice utterance is falsified or not, but on the other hand, causes much inconvenience for a speaker which is annoying for speakers and undesired for non-fraudulent speakers. In the present method it is, therefore, preferred to have other less annoying tests beforehand, or to have no previous tests beforehand (which would give only less reliable results).

The liveliness of the speaker can be checked, for example, by providing a pool of at least 100, 500, 1,000, 2,000 or 5,000 or more stored sentences which can be forwarded in a suitable manner to the speaker. They can be forwarded, for example, by audio rendition via a telephone connection, or by sending an electronic message by email or SMS or the like. The sentence preferably is a sentence which was not used beforehand during a new registration or training phase of the speaker, which may have been carried out before performing the method for verifying the identity in order to make sure that such a sentence was not yet been spoken by the speaker and, hence, could not have been recorded beforehand.

The selection of the sentence may be done by random. Additionally it may be checked that for one and the same identity which needs to be verified never the same sentence is used twice. After having selected such a sentence, the speaker is requested to speak the selected sentence and a further voice utterance can be received. It is preferred that a sentence comprising a plurality of words such as at least 3, 4 or 5 words is used in order to make sure that such a sentence has never been pronounced by the speaker before.

Upon having received a further voice utterance, first a voice recognition step is performed in order to determine the semantic content of the further voice utterance, with the aim to determine that the semantic content of the received voice utterance corresponds to that of the selected sentence. Here it is to be pointed out that while in the verification of the speaker's voice any semantic content is usually suppressed and only individual characteristics of a voice are used which are commonly independent of semantic contact, while, when determining the semantic content any particular characteristics of the voice are to be suppressed in order to determine only the semantic content independent of the voice.

Furthermore, biometric voice data are used to verify that the speaker's voice corresponds to the identity which it is to be verified based on the further voice utterance.

By combining those two tests, it is firstly determined that an alive speaker is presently capable of pronouncing a particular sentence on demand, such that the possibility that the received further voice utterance has been recorded beforehand is minimized and secondly the identity of the speaker is verified based on the same voice utterance.

In further preferred embodiments, it is possible that the different steps are arranged in such a way that the method performs one, two, three or more loops, wherein, in each loop a further voice utterance is requested, received and processed. The processing of such a further received voice utterance preferably has one, two, three or all of a group of sub steps comprising: using biometric voice data to verify that the speaker's voice corresponds to the identity of the speaker, the identity of which is to be verified based on the received further voice utterance; determining exact match of the further received voice utterance with any previously received voice utterance during execution of the method, Le. in one session (all previously received voice utterances, the lastly received previous voice utterance, the last two previously received voice utterances, etc.), determining the falsification of the further received voice utterance without processing any other voice utterance for this particular sub-step and checking liveliness of the speaker.

Any of the above or below described methods provide a result which is indicative of the speaker's being accepted or rejected. This result can be used for granting or denying access to a protected system such as, e.g., a telephone banking system or an online internet based banking access system which can additionally handle voice transmissions.

Other applications of the method are possible as well such as e.g. in a method of informing a person of an event and a method of receiving information about an event such as disclosed in the international application with application number PCT/EP2008/002778.

Further the method may be used in a method of generating a temporarily limited and/or usage limited means and/or status, method of obtaining a temporarily limited and/or usage limited means and/or status such as disclosed in the international application with application number PCT/EP2008/002777.

Also the method may be used in a method for Localizing a Person, System for Localizing a Person such as disclosed in the international application with application number PCT/EP2008/003768.

The text of those three applications in incorporated entirely by reference.

The method is preferably carried out by or implemented in a computer. This computer may be part of a computing system. The computer or computing system may be part of a telephone service system that provides some service such as a telephone banking service, for which access is restricted and the restriction needs to be overcome by identification.

The method may be executed upon an incoming phone call received by a speaker or any other communication capable of transmitting audio data. Such phone call or communication initiates a session for verification of a speaker's identity.

The present invention also refers to a computer readable medium having instructions, thereon, which when executed on a computer perform any of the above or below described methods. Equally, the invention refers to a computer system having such a computer readable medium.

Utterances of the speaker may have been provided before performing the method for verifying the identity of the speaker (in a training or registration phase) in order to evaluate such voice utterances, such that biometric voice data can be extracted thereof. Those biometric voice data can then be used for verification that the speakers voice corresponds to the speaker the identity of which is to be verified.

Biometric voice data may be extracted from a voice utterance by a frequency analysis of the voice. From a voice utterance sequence of e.g., 20 or 30 milliseconds, may be Fourier transformed and from the envelope thereof, biometric voice data can be extracted. From multiple of such Fourier transformed voice sequences a voice model can be generated named a Gaussian Mixed Model (GMM). However, any other voice data that allows distinguishing one voice from another voice due to voice characteristics may be used. Also, voice characteristics that take into account that the voice utterance refers to specific semantic content can be considered. For example, Hidden Markow Models (HMM) may be used which take into account transmission probabilities between different Gaussian Mixed Models, each of which refers to a sound or letter within a word.

Some preferred embodiments of the present invention are disclosed in the figures. Those figures show some examples only, and are not limiting the invention.

### BRIEF DESCRIPTION OF THE DRAWING FIGURES

FIG. 1a is a flow diagram illustrating a method for verifying the identity of a speaker.

FIG. 1b is a flow diagram illustrating a method for verifying the identity of a speaker.

FIG. 2 is a flow diagram illustrating a method verifying the identity of a speaker.

FIG. 3 is a flow diagram illustrating a method verifying the identity of a speaker.

FIG. 4 is a flow diagram illustrating a method for verifying the identity of a speaker.

FIG. 5 is a flow diagram illustrating a method for verifying the identity of a speaker.

FIG. 6 is a flow diagram illustrating a method for verifying the identity of a speaker.

FIGS. 7a-d are a series of flow diagrams illustrating various methods for verifying the identity of a speaker.

FIGS. 8a-b are a series of flow diagrams illustrating various methods for verifying the identity of a speaker.

### DETAILED DESCRIPTION

The invention is related to providing an improved system for classifying whether audio data received in a speaker recognition system is genuine or a spoof.

Typically, high degradation of the audio signal data results when a person impersonates another person (“spoof”) using a technique like voice transformation, or recording of a victim (e.g. replay attack). In particular, high degradation may mean that the degradation is higher than degradation present in a genuine audio signal. This is an example of what may be meant by the expression “spoof” in this application.

The invention comprises a system for classifying whether audio data received in a speaker recognition system is genuine or a spoof. In such a system, a Gaussian classifier is used.

Herein, audio data usually corresponds to or comprises an audio data file or two, three, four or more audio data files.

A system according to the invention may be used in combination with different types of speaker recognition systems or be comprised in different types of speaker recognition systems.

A system according to the invention is in particular a system adapted to classify whether audio data received in a speaker recognition system is genuine or a spoof using a Gaussian classifier. A system according to the invention may be adapted to be used exclusively to determine if received audio data is genuine or a spoof.

It may for example, be used in combination with or be comprised in a speaker verification system, wherein the focus of the speaker recognition is to confirm or refuse that a person is who he/she says to be. In speaker verification, two voice prints are compared, one of the speaker known to the system in advance (e.g. from previous enrollment) and another extracted from the received audio data. A system according to the invention may alternatively or additionally be used in combination with or be comprised in a speaker identification system. In speaker identification, the system comprises or has access to voice prints from a set of N known speakers and has to determine which of these known speakers the person who is speaking corresponds to. The voice print extracted from the received audio data is compared against all N voice prints known to the system (e.g. from previous enrollment(s)). A speaker identification system can be open-set, wherein the speaker is not necessarily one of the N speakers known to the system, or closed-set, if the speaker is always in the set of speakers known to the system. The term speaker recognition comprises both speaker verification and speaker identification.

A system according to the invention may also be used in combination with or be comprised in a speaker recognition system (speaker verification and/or speaker identification) which is text-dependent, meaning that the same lexical content (e.g. a passphrase) has to be spoken by a speaker during enrollment and during recognition phases or in a text-independent system, wherein there is no constraint with regard to the lexical content used for enrollment and recognition.

A system according to the invention may be a passive system, meaning that no additional audio data may be needed once the audio data to be classified is received.

In a system according to the invention, a Gaussian classifier is used. This means that the classification is based on a model described by 1, 2, 3, 4, or more Gaussian probability density functions (Gaussians).

In particular, in a system according the invention, 1, 2, 3, 4, or more Gaussians may be used to model the spoof region of audio data parameters. Additionally or alternatively, 1, 2, 3, 4, or more Gaussians may be used to model the genuine region of audio data parameters. The spoof region of audio data parameters may e.g. be modeled by a Gaussian Mixture Model (GMM) and/or the genuine region of the audio data parameters may be modeled by a GMM.

A Gaussian mixture model may comprise C Gaussians, wherein C may be 1, 2, 3, 4 or more. Each Gaussian comprised in a Gaussian mixture model is called a component. These components are indicated by c.

The Gaussian classifier may be a full-covariance Gaussian classifier, e.g. a Gaussian classifier in which each Gaussian is described including a full covariance. In other embodiments, less than a full-covariance Gaussian classifier may be used, e.g. a diagonal covariance Gaussian classifier may be used.

C_{spoof} may indicate that the number of Gaussians in the Gaussian mixture model describing the spoof region of parameters describing audio data, C_{non-spoof} may be the number of Gaussians (components) in the Gaussian mixture model describing the genuine (non-spoof) audio data.

Each component of such a model describing the (non-)spoof region of parameters describing audio data may be denoted by c_{(non-)spoof}. When using the expression cin the text, this may refer to c_{spoof} and/or c_{non-spoof} and may also be written as c_{(non-)spoof}. The same notation may also be used for other expressions, e.g. C, w, etc.

The above-mentioned case wherein the spoof region of parameters describing audio data is described by one Gaussian and/or wherein the non-spoof region of parameters describing audio data is described by one Gaussian may be particularly suitable for cases where the audio data is not sufficient to create a more complex model. It is a special case of the Gaussian mixture model wherein C_{(non-)spoof}=1.

Although C_{spoof} and C_{non-spoof} may have different values in general, they may have the same value in some embodiments C_{spoof}=C_{non-spoof} because that way the likelihoods given by the spoof and non-spoof model may be more easily comparable. C_{spoof} and/or C_{non-spoof} may be 1 in some embodiments.

C_{spoof} and/or C_{non-spoof} may each be 1, 2, 3, 4 or more, as indicated previously.

In a system according the invention, the audio data parameters which may be considered may comprise a spectral ratio. The spectral ratio may for example be the ratio between the signal energy from 0-2 KHz and from 2-4 KHz or the ratio of the signal energies in two other spectral ranges.

For the spectral ratio being the ratio of the signal energy from energy from 0-2 KHz and from 2-4 KHz, given a frame 1 of the audio data x(t), the spectral ratio for frame l may for example be calculated as:

$$SR ( l ) = {\sum }_{f = 0}^{\frac{NFFT}{2} - 1} 20 {log}_{10} ( \vert X ( f , l ) \vert ) \sqrt{\frac{4}{NFFT}} Cos ( \frac{( 2 f + 1 ) π}{NFFT} ) \qquad ( 1 )$$

Herein, X(fl,) is the Fast Fourier Transform (FFT) of the frame l of the audio data x(t), and NFFT is the number of points of the FFT. NFFT may for example be 256, or 512 or another suitable number. l may lie between 1 and L, L being the total number of (speech) frames present in the audio data x. Optionally, the spectral ration may only be calculated for speech frames (explained further below).

A frame of audio data refers to a (usually small) part of the audio data. For example, audio data, e.g. an audio data file, may be cut up into separate parts, wherein each part corresponds to a certain time interval of the audio data, e.g. 10 ms or 20 ms. Then, each of those parts is a frame of the audio signal. A frame of an audio data may e.g. be created by considering a window with a window length of a certain time, e.g. 20 ms, with a shift of a certain time, e.g. 10 ms.

The average value of the spectral ratios SR_{audio} may then be calculated. It may e.g. be calculated as the mean of the spectral ratios of all speech frames, which may be defined as frames of which the modulation index is above a given threshold, which may for example be 0.5, 0.75 or 0.9. This modulation index may be used as a complement to or as an alternative to a Voice Activity Detector (VAD). The modulation index is a metric that may help or enable one to determine if the analyzed frame is a conventional speech frame. The modulation index at a time t may be calculated as:

$$Idx ( t ) = \frac{{v}_{max} ( t ) - {v}_{min} ( t )}{{v}_{max} ( t ) + {v}_{min} ( t )} \qquad ( 2 )$$

where v(t) is the envelope of the signal x(t) and vₘₐₓ (t) and vₘᵢₙ (t) are the local maximum and minimum of the envelope in the close surrounding to the t time stamp. The envelope may e.g. be approximated by the soluble absolute value of the signal x(t) downsampled to 60 Hz.

Another parameter of the audio data which may be considered in a system according to the invention in addition or alternatively to the spectral ratio is the feature vector distance.

A feature vector distance may be computed relative to parameters describing average feature vectors of genuine audio data.

The audio data from which average feature vectors may be calculated may e.g. be audio data which is known to the speaker recognition system and/or the system according to the invention, typically from a previous enrollment. For example, the feature vector distance may be computed relative to parameters describing average feature vectors of audio data used for the enrollment of one, two or more speakers for the speaker recognition system.

For example, in a system according to the invention used in combination with or comprised in a speaker verification system, the feature vector distance may be calculated relative to parameters describing average feature vectors of the enrollment audio data of the speaker who is to be verified. As a different example, in a system according to the invention used in combination with or comprised in a speaker identification system, the feature vector distance may be calculated relative to parameters describing average feature vectors of the enrollment audio data, e.g. audio data of 1, 2, 3, four, more than four or all N speakers known to the speaker identification system.

One or more or all of the parameters describing average feature vectors of audio data may be given by a constant value, which may e.g. be provided in the system according to the invention or by a third party and/or they may be transferred from a speaker recognition system, e.g. over an interface and/or they may be calculated in a system according to the invention e.g. from enrollment audio data, e.g. as previously described.

If the parameters describing average feature vectors of audio data are calculated in a system according to the invention, D dimensional Mel Frequency Cepstral Coefficients MFCCs are one possible option to describe feature vectors of audio data. Thus, average feature vectors of audio data may e.g. be calculated by calculating the mean μ_{mfcc,d} of Ddimensional MFCCs in one, two, three, or more or each dimension d∈[1;D] and/or calculating a standard deviation σ_{mfcc, d} thereof for one, two, three or more or each dimension d∈[1;D] over the considered audio data and over time, optionally taking into account only those parts of the considered audio data comprising voice signals, e.g. as explained in the following. D may e.g. be fixed heuristically, and may e.g. be a number from 5-30, e.g. from 7-25, e.g. from 9-20.

In particular, D dimensional MFCCs may be extracted from each of the considered audio data files (e.g. enrollment audio data files).

In that manner, for each audio data file j∈[1;J] of the considered audio data a sequence of

MFCCs: mfcc _{j t d,} may be extracted. Herein J is the number of the considered audio data files, t is the frame index with a value between 1 and Tⱼ(t∈[1;Tⱼ]), wherein Tⱼ is the total number of

(speech) frames for audio data file j. Optionally, only those parts of the audio data file j comprising voice signals are taken into account for extracting the MFCCs, e.g. by using a Voice Activity Detector (VAD). d is a value between 1 and D(d∈[1;D]) representing the considered dimension.

In some exemplary embodiments of systems according to the invention, no feature normalization is be used when extracting the MFCCs.

From the sequence of MFCC's, the mean along t may be computed as:

$${μ}_{mfcc , j , d} = \frac{1}{{T}_{j}} {\sum }_{t = 1}^{{T}_{j}} {mfcc}_{j , t , d} \qquad ( 3 )$$

Given J data files, from each of the J data files D dimensional MFCCs C₁, C₂, . . . C_{D} may be extracted as previously mentioned. Then, the mean μ_{mfcc,d} and the standard deviation σ_{mfcc,d} over all J data files may be calculated e.g. as indicated in the following:

$$\begin{matrix}{μ}_{mfcc , d} = \frac{1}{J} {\sum }_{j = 1}^{J} {μ}_{mfcc , j , d} & ( 4 ) \\ {σ}_{mfcc , d}^{2} = \frac{1}{J - 1} {\sum }_{j = 1}^{J} {( {μ}_{mffc , j , d} - {μ}_{mffc , d} )}^{2} & ( 5 )\end{matrix}$$

In some embodiments of a system according to the invention, the mean of the MFCCs in one, two, three, more or each dimension d of the D dimensions and/or the standard deviation(s) of the mean of the MFCCs in one, two, three or more or all d of the D dimensions may, instead of being calculated, be a given constant value, which may e.g. be provided in the system according to the invention or by a third party and/or they may be transferred from a speaker recognition system, e.g. over an interface.

The feature vector distance may be determined by determining an absolute value of the difference between the parameters describing the audio data received in the speaker recognition system which is to be classified from the parameters describing average feature vectors of audio data.

When MFCCs are used to describe the feature vectors, the feature vector distance of the audio data file may be calculated using the MFCCs. It may for example be found by first calculating the mean of the MFCCs of the received audio data μ_{mfcc,audio,d} in each dimension d, e.g. as:

$${μ}_{mfcc , audio , d} = \frac{1}{{T}_{audio}} {\sum }_{t = 1}^{{T}_{audio}} {mfcc}_{audio , t , d} \qquad ( 6 )$$

Herein, T_{audio} corresponds to the number of speech frames (e.g. found by using a VAD) of the received audio data optionally taking into account only those parts of the received audio data comprising voice signals.

Then, the feature vector distance Δ_{audio} of the received audio data may be determined by summing up over all dimensions d∈[1;D] the absolute value of the difference between the mean value μ_{mfcc,d} (4) of the MFCCs in dimension d and the mean of the MFCCs μ_{mfcc,audio,d} (6) of the received audio data in the dimension d divided by the standard deviation σ_{mfcc,d} (5) of the mean MFCCs in dimension d, e.g. as follows:

$${Δ}_{audio} = {\sum }_{d = 1}^{D} \frac{\vert {μ}_{mfcc , d} - {μ}_{mfcc , audio , d} \vert}{{σ}_{mfcc , d}} \qquad ( 7 )$$

A system according to the invention may use 1, 2, 3, 4 or more parameters describing the audio data as parameters to classify whether audio data received in a speaker recognition system is genuine or a spoof.

In a system according to the invention, the two previously discussed parameters of the audio data, namely, a spectral ratio and a feature vector distance, may be the only parameters used for classifying whether an audio data received in a speaker recognition system is genuine or a spoof. In other embodiments of the system according to the invention, there may in addition, or alternatively to one or both of these parameters, be one, two, three or more different parameters also describing the audio data. The parameters describing the audio data may be written in a

vector having as many dimensions as there are parameters which are considered in a model for describing the audio data (the spoof region of audio data parameters and the genuine region of audio data parameters).

In embodiments wherein a feature vector distance and a spectral ratio are the only parameters describing the audio data received in the speaker recognition system, each audio data file may for example be represented by a two-dimensional vector:

$${y}_{audio} = ( \begin{matrix}{Δ}_{audio} \\ {SR}_{audio}\end{matrix} ) \qquad ( 8 )$$

In other embodiments, this vector may have as many dimensions as there are parameters of the audio data. For example, it may have more dimensions than 2 or less dimensions than 2 or may have 2 dimensions, but different variables than in the previously mentioned embodiment.

For example, in other embodiments, in addition or alternatively to one or more of the abovementioned parameters describing the audio data, Low Frequency Mel Frequency Cepstral Coefficients (in the following also referred to as LF-MFCC) and/or Medium Frequency Relative Energy (MF) may be used.

For example, the audio data parameters which may be considered may comprise a medium frequency relative energy (MF). MF is the ratio between the energy of a signal from a certain frequency band (fₐ, f_{b}) and the energy of the complete frequency spectrum of the signal.

MF may in some embodiments be or represent a ratio along the frames of the energy of a filtered audio and the energy of the complete audio.

In calculating MF, the filter may be built to maintain certain (relevant) frequency components of the signal. The relevant frequency components may be selected according to the spoof data which should be detected (e.g. according to the frequency characteristics of loudspeakers which are typically used for spoof in replay or other attacks, e.g. by taking into consideration certain frequency ranges which are typical for such loudspeakers). Such a selection may e.g. be made based on training or develop data, e.g. samples of spoof audio data.

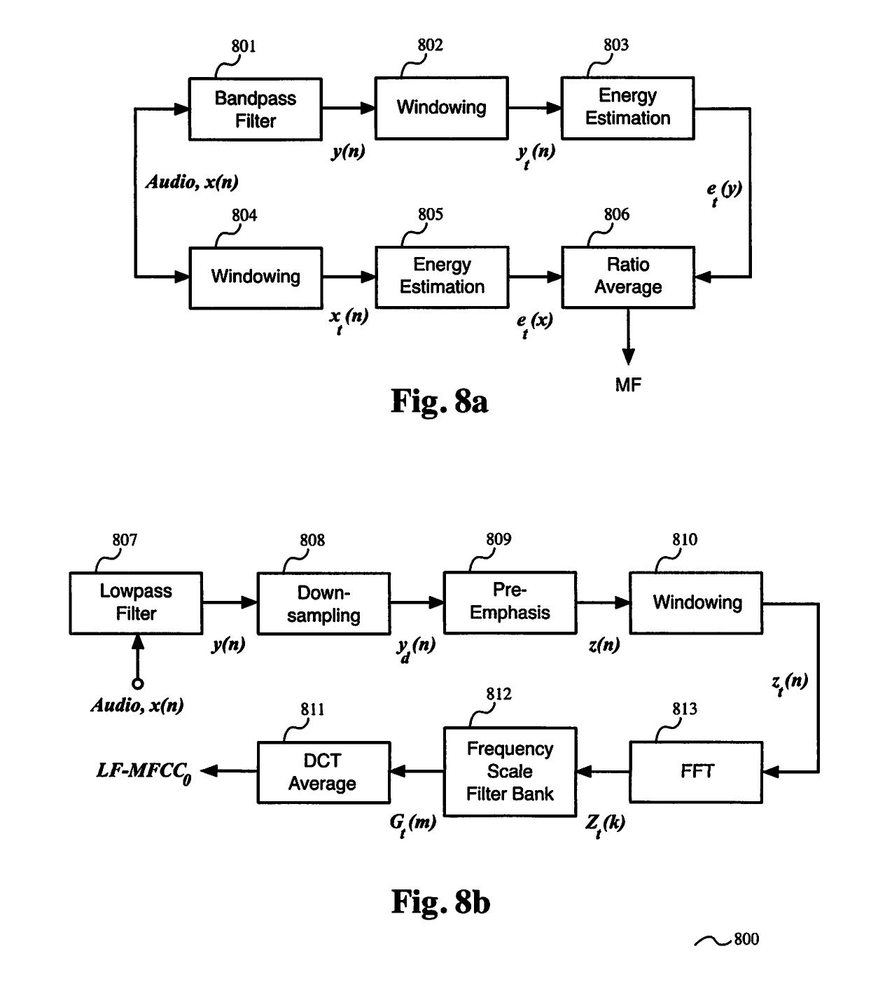

MF may be extracted by filtering the audio signal x(n) (herein, x(n) may correspond to an audio signal which has previously been written as x(t), t being the time. However, as t is used as frame index in the following calculations, the audio signal may in the following paragraphs and FIG. 8a also be referred to as x(n), with n referring to the particular sample. x(n) (as x(t)) is typically in the time domain) with a band pass filter (e.g. a narrow band pass filter) to extract the frequency components of the desired band (fₐ, f_{b}), thus for example generating data referred to as y(n).

Then, both the initial audio signal x(n) and the filtered version y(n) may be windowed (e.g. using Hamming windowing), thus for example generating data referred to xₜ(n) (for the audio signal) and yₜ(n) (filtered audio signal) for the t-th frame (t=1, 2, 3, 4, . . . T, wherein T is the number of frames of the audio).

Then, a value indicative of the energy corresponding to a window t may be computed as:

e_{y}(t)=max(10log₁₀(Σₙ(yₜ(n))²),−150), (9)

eₓ(t)=max(10log₁₀(Σₙ(yₜ(n))²),−150), (10)

and the average ratio of the values indicative of the energy corresponding to a window may be computed as:

$$MF = \frac{1}{M} {\sum }_{m} ( {e}_{x} ( m ) - {e}_{y} ( m ) ) \qquad ( 11 )$$

(As a logarithm has been used in equations (9) and (10), such a ratio may be calculated by subtracting the two values indicative of the energy corresponding to a window m.) Herein, in some embodiments only those M frames (wherein m lies between 1 and M (e.g. m=1, 2, 3, . . . M), in the previous expression) may be considered for which for example eₓ(m)>maxₜ(eₓ(t))−50), or, in other words, such that the average is estimated with the frames with highest energy (e.g. an energy higher than a certain threshold) for xₜ(n). Other thresholds than the one mentioned above may also be used. In other embodiments, all frames may be considered when calculating MF (e.g. M=T).

The narrow-band pass filter (band pass filter) can be designed in many different ways.

In one embodiment a Cauer approximation may be used with a lower stop frequency of fₐ−γₐ and a lower pass frequency of fₐ with a minimum attenuation in the lower stop band of φₗₛ. In the higher stop frequency, the minimum attenuation may be φₕₛ with the higher pass frequency located at f_{b}−γ_{b} and the higher stop frequency at f_{b}. These variables may depend on the properties of the replaying loudspeakers that are to be detected and/or the available resources to evaluate the bandpass filter. For example, fₐ may be approximately 100 Hz, for example between 50 and 150 Hz, γₐ may be approximately 20 Hz, for example between 10 Hz and 30 Hz, φₗₛ may be approximately 60 dB, for example between 50 dB and 70 dB, φₕₛ may be approximately 80 dB, for example between 70 dB and 90 dB, f_{b} may be approximately 200 Hz, for example between 150 Hz and 250 Hz and γ_{b} may be approximately 20 Hz, for example between 10 Hz and 30 Hz.

For example, the audio data parameters which may be considered may alternatively or additionally comprise LF-MFCC. LF-MFCC may be designed to represent a kind of energy ratios of the envelope of the spectrum of an input signal, but only in a (low-) frequency region between two frequencies f_{d} and fᵤ

In the computation of MF and/or LF-MFCC, for example, Cauer filters (a Cauer approximation) may be used to extract relevant frequency information. The nomenclature between MF and LFMFCC is typically different because the filters may be different.

As is known to a person skilled in the art, a Cauer approximation is a way to build signal processing filters. Given a frequency band (band pass) to be preserved, the minimum attenuation for the non-pass band(s) and the frequency range or band to get the desired minimum attenuation have to be defined. The desired minimum attenuation can usually not be obtained at a frequency of 0 Hz (infinite slope). Usually, the higher the minimum attenuation and the lower the frequency band(s) or range(s), the more complex the filter is and the more time is needed to run the algorithm. For example, for a band pass between f_{d} and fᵤ, the frequency band or range to get the desired minimum attenuation for lower non-pass band is typically f_{d}−y_{d} to f_{d}, the frequency band or range to get the desired attenuation for the higher non-pass band is from fᵤ−γᵤ, to fᵤ, and the minimum attenuation for lower non-pass band (from 0 Hz to f_{d}−γ_{d}) is φₗₛ while the minimum attenuation for the higher non-pass band (from fᵤ to infinity) is φₕₛ.

In a Cauer solution to extract LF-MFCC, the lower stop frequency may be f_{d}−γ_{d} and the lower pass frequency may be f_{d} with a minimum attenuation in the lower stop band of φₗₛ. In the higher stop frequency, the minimum attenuation may be φₕₛ with the higher pass frequency located at fᵤ−γᵤ and the higher stop frequency at fᵤ.

These variables may for example be determined depending on the properties of the loudspeakers that is to be detected when used in a replay attack and/or the available resources for evaluating the band pass filter.

In other embodiments, the band pass filter may be a low pass filter with f_{d}=0 Hz=γ_{d}.

fᵤ may for example have a value of about 500 Hz, for example between 250 Hz and 750 Hz.

Defining φₗₛ may not be necessary when using such a low pass filter, φₕₛ may have value of approximately 80 dB, for example between 60 dB and 100 dB, and γᵤ may have value of approximately 20 Hz, for example between 10 Hz and 30 Hz.

Typically, LF-MFCC may be found by applying the above-mentioned band pass filter to the audio data x(n) (the audio signal).

Then, the obtained result of the band pass filter (which may be described as y(n)) may optionally be downsampled (to be described by y_{d}(n)), meaning for example that the filtered signal may be compressed, such that less information needs to be processed. The rate which can be used for the downsampling without loss of (relevant) information typically depends on fᵤ and/or the frequency rate of the audio signal.

For example, given a sample frequency (fₘ) used to record an audio signal, the maximum frequency component of the audio is typically fₘ/2. If the signal is filtered (e.g. with a low pass filter), and the higher stop frequency is fᵤ, one sample per floor (fₘ/2fᵤ) is typically sufficient in order to have all the relevant information (lose no information after filtering). Herein, floor (**) is the integer part of **.

For example, for an audio recorded at approximately 8 kHz and fᵤ=500 Hz, the filtered signal may be reduced by a factor 8 without loss of information, thus reducing the time necessary for computing drastically.

After the optional downsampling (or in some embodiments directly after the band pass filter), a pre-emphasis filter may optionally be applied to flatten the speech signal spectrum compensating an inherent tilt due to radiation phenomenon along with the glottal pulse spectral decay. Such pre-emphasis filter may for example correspond to the ones known from traditional speech front-ends or be different. (An exemplary description of what may be meant by downsampling in some embodiments can for example be found in “Discrete-Time Signal Processing” (2^{nd} edition) Prentice Hall, by Openheim, Alan v; Schafer, Ronald W.; Buck, John. R).

For example, as a pre-emphasis filter a first order high pass FIR filter with a coefficient ζ may be used. It has been found that a value of approximately 0.87 for ζ has a good discrimination between spoof and non-spoof audios. For example, ζ may for example be between 0.77 and 0.97, for example between 0.82 and 0.92.

Thus, a filtered portion of the previous signal (e.g. y_{d}(n)) is typically extracted (which may e.g. be referred to as z(n)).

Then, the signal may be windowed, for example using a Hamming window with a length of approximately 320 ms and approximately 50% overlap, for example a length between 220 and 420 ms and between 25% and 75% overlap. Thus, for each frame t (window) thus a value zₜ(n) is obtained. Because the frequency band under analysis is typically quite low, usually longer periods than the ones usually considered in speech technology solutions (e.g. 20 ms) are typically considered.

The values obtained by the windowing zₜ(n) may then be further processed, e.g. to extract an estimation of the spectrum (power spectral density). This may, for example, be done by a Fast Fourier Transformation (FFT) and determination of the absolute value of zₜ(n), thus obtaining a value Zₜ(k). Herein, FFT(zₜ(n)) is typically a complex signal, so that the absolute value |IFFT(zₜ(n)|=Zₜ(k) may be extracted in some embodiments. Herein, k typically represents the frequency domain. (Typically, non-parametric methods which may be used for estimation of the spectrum (estimation of the power spectral density) like a periodogram or the Welch method rely on FFT). In other embodiments, an estimation of the spectrum may be extracted with other methods, such as parametric solutions, e.g. using Auto Regressive (AR) modeling and/or linear prediction analysis. In such parametric methods, the information is typically embedded in the AR coefficients. Thus, linear prediction coefficients and/or the derived estimate of the power spectral density of the signal under analysis may be used as estimation of the spectrum.

With regard to how spectral estimation may be carried out, reference is also made to Kay, S. M. Modern Spectral Estimation: Theory and Application. Englewood Cliffs, NJ: Prentice-Hall, 1988.

Then, spectral smoothing may optionally be applied. This may for example be done in accordance with the methods used by current speech front-ends that try to extract the short-term representation of the spectral envelope for each frame using some kind of smoothing of the raw spectral measurements with non-linear operations. This may for example be done as it has been done traditionally, namely to remove the harmonic structure of speech corresponding to pitch information and to reduce the variance of the spectral envelope estimation. In addition to this, the number of parameters representing each frame spectrum may also be reduced by this.

This spectral smoothing may for example be performed by means of a bank of filters operating in the frequency domain by computing a weighted average of the magnitude of the absolute values of the FFT for each audio window, thus rendering Gₜ(m). The number of filters and the bandwidth of each filter may be similar or varied with regard to the conventional ones used in speech technology in order to obtain higher resolution in the representation of the frequency band which showed to be more discriminative to classify spoof and non-spoof data. The number of filters and/or the bandwidth of each filter may e.g. be determined based on fᵤ. Traditionally, for example a 20/24 filter structure may be used in speech technology, while in other embodiment of this invention, the number of filters may be approximately 80, for example between 70 and 90. For example, spectral smoothing may be done by Mel filtering. After the MEL filtering the log of each coefficient m may be taken. (Herein, Mel filtering typically consists of or comprises building a set of filters using the Mel scale and applying them to the signal (e.g. the absolute value of the FFT of the audio signal (one frame)). Mel filters are typically triangular. Reference in this regard is also made to MFCCs, and S. B. Davis, and P. Mermelstein: “Comparison of Parametric Representations for Monosyllabic Word Recognition in Continuously Spoken Sentences”, (1980) in IEEE

Transactions on Acoustics, Speech and Signal Processing, 28(4), pp. 357-366.)

The number of MEL filters may depend on the degree of smoothness intended for the embodiment. For example, if fᵤ=500 Hz and a lot of filters are built, the resolution of the filtered signal Gₜ(m) is typically very high, but also very noisy. If very few (fewer than in the comparison case) filters are built, the resolution of Gₜ(m) is usually poor (e.g. poorer as in the case with many filters), but it is not as noisy (as e.g. in the case of a high resolution filtered signal Gₜ(m)). The bandwidth of the filters may for example depend on the ration between fᵤ and the number of filters: the higher the ratio, the higher the bandwidth.

After the optional spectral smoothing, a Discrete Cosine Transformation (DCT) may be used, which is a well-known linear transformation which is popular due to its beneficial properties that may e.g. allow compact and decorrelated representations. With such a DCT LF-MFCCₜ(r) may be extracted from Gₜ(m). The number R of LF-MFCCₜ(r) (r∈[1,R]) may not be the same as the number M of coefficients of Gₜ(m) (m∈[1,M]) . In other embodiments, the numbers R and M may be the same. The output of the DCT module may for example be seen as a compact and systematic way to generate energy ratios.

Given one audio and one frame (t), for example, O coefficients may be generated (which may typically be relevant): LF-MFCC_{t,o}(o∈[1,0]). Herein, O may be 1, 2, 3, 4 or more, for example typically e.g. 3, e.g. between 2 and 4). LF-MFCCₒ may then be computed by averaging the LFMFCC_{t,o}, for example for some or all speech frames.

Herein, a speech frame may for example be determined using a conventional voice activity detector. In other embodiments, a particular coefficient LF-MFCC_{t,0}(LF-MFCC_{t,zero}) may be considered as an energy estimation of each frame, so that only those frames may be selected as speech frames which have the highest estimated energy (e.g. the 10% of the frames with highest energy, or the 50% of the frames with highest energy, or all frames with an energy above a certain value).

Typically, calculating LF-MFCC is a systematic and compact way to calculate energy ratios. (In the above-mentioned example, to compute LF-MFCC, a low pass filter may be used so that all the energy ratios are focused in a low frequency band. In some embodiments, without applying DCT, the output of LF-MFCC for a given frame would be a smooth version of the frequency spectrum in a log domain e.g. when computed by the FFT, absolute value, Mel filtering and log. After an optional DCT is computed, which typically uses a cosine base (with different frequencies), multiplying the cosine base with the smooth version of the spectrum, each frequency of the cosine basis which represents a coefficient of the LF-MFCC, is an energy ratio: Some of the log energy spectrum energies (log spectrum bins) may be multiplied by positive values and some of the log spectrum entries (log spectrum bins) may be multiplied by negative values and at the end all the multiplied log energies may be added to generate the corresponding LFMFCC.) Since, for example, some spoofs (e.g. replay attacks) are built with loudspeakers, the relevant energy ratios to detect the spoof audios typically depend on the frequency response of the loudspeakers. Because of that, some LF-MFCC coefficients (relevant coefficients) may be more discriminative than others in order to detect a certain loudspeaker, e.g. a replay attack.

Thus, the O coefficients (or parts thereof) (which may e.g. comprised in the parameters describing the audio data) may be selected, e.g. with develop data (e.g. from known loudspeakers which may be used in replay attacks) or a priori knowledge, or to build an anti-spoofing solution adapted for a wide range of loudspeakers. For such applications, O may e.g. be 1, 2 or 3.

For example, the O LF-MFCC coefficients may be selected according to the spoof data which should be detected (e.g. according to the frequency characteristics of loudspeakers which are typically used for spoof in replay or other attacks, e.g. by taking into consideration certain frequency ranges which are typical for such loudspeakers). Such a selection may e.g. be made based on training or develop data, e.g. samples of spoof audio data.

In some embodiments, if the loudspeaker frequency response is known (an example of a priori knowledge), the (relevant) energy ratios (e.g. O LF-MFCC coefficients) can be selected to describe this loudspeaker frequency response well. If the frequency response of the loudspeakers is not known, but spoof data (an example of develop data) is available, the most discriminative energy ratios (e.g. O LF-MFCC coefficients) can be determined heuristically.

In some embodiments of the invention, a DC offset removal module, which is typically used in conventional speech based front ends, may be used, while in other embodiments of the invention, though such DC offset removal module may not be used. A DC offset removal module may for example be designed as a high pass filter.

There may thus be O different LF-MFCC considered resulting in a O dimensional vector of LFMFCC.

The value of φₕₛ and φₗₛ for the model used for finding MF may be the same or different from each other. The values of φₕₛ and φₗₛ used in the model for finding the LF-MFCC may also be the same, or may be different.

In some embodiments, MF and LF-MFCC may be comprised in the parameters (or be the parameters) describing the audio data parameters. In that case, fₐ may correspond to f_{d}, and/or f_{b} may correspond to fᵤ. In other embodiments comprising MF and LF-MFCC, fₐ may not correspond to f_{d} and/or f_{b} may not correspond to fᵤ.

Accordingly, in some embodiments comprising MF and LF-MFCC γₐ may have the same value as or a different value than γ_{d} and/or γ_{b} may have the same value as or a different value than γᵤ. Furthermore, φₗₛ for the model used for finding MF may correspond to or be different from φₗₛ used in the model for finding the LF-MFCC and/or φₕₛ for the model used for finding MF may correspond to or be different from φₕₛ used in the model for finding the LF-MFCC.

Optionally, γₐ may have the same value as or a different value than γᵤ, and/or γ_{b} may have the same value as or a different value than γ_{d}.

When MF and LF-MFCC are use or comprised in the parameters describing the audio data, the vector describing the audio data has 1+O or at least 1+O dimensions (1 for the MF, O (the number of coefficients) for the LF-MFCC). For example, in one embodiment the audio may be described by a vector which has O+1 dimensions:

$${y}_{audio} = ( \begin{matrix}MF \\ {LF\_MFCC}_{o}\end{matrix} ) \qquad ( 12 )$$

In a system according to the invention, initial parameters for the Gaussian classifier may be derived from training audio data, usually training data files. Typically, more than 40, for example more than 100 different training audio data files are used. The training audio data may comprise or consist of enrollment audio data of a previous enrollment into a speaker recognition system.

The parameters for the Gaussian(s) of the Gaussian classifier, for example, mean vector(s) describing the spoof audio data μ_{spoof,1}, and optionally μ_{spoof,2}, . . . (μ_{spoof}, c_{spoof}, with c_{spoof}∈[1,C_{spoof}]) and/or mean vector(s) describing genuine (non-spoof) audio data μ_{non-spoof,1} and optionally μ_{spoof,2}. . . (μ_{spoof}, c_{non-spoof}, with c_{non-spoof}∈[1,C_{non-spoof}]) and covariance matrix/matrices Σ_{non-spoof,1}, and optionally Σ_{non-spoof,2}. . . (Σ_{non-spoof}, c_{non-spoof}, with c_{non-spoof}∈[1,C_{non-spoof}]) describing non-spoof distribution(s) and/or covariance matrix/matrices describing spoof distribution(s) Σ_{spoof,1}, and optionally Σ_{spoof,2}. . . (Σ_{spoof}, c_{spoof}, with c_{spoof}∈[1,C_{spoof}]) may be determined.

For determining the mean vector(s) describing the spoof audio data and/or covariance matrix/matrices describing spoof distribution(s), spoof audio data may be required.

For determining the mean vector(s) describing genuine (non-spoof) audio data and/or covariance matrix/matrices describing genuine (non-spoof) distribution(s), genuine audio data may be required.

Each covariance matrix which is determined may be diagonal or non-diagonal.

For describing one Gaussian, a mean vector and a covariance matrix are required. They are typically estimated by a suitable algorithm, e.g. by an Expectation Maximization algorithm (EM) (as disclosed e.g. in A. P. Dempster, N. M. Laird and D. B. Rubin, “Maximum likelihood from incomplete data via the EM algorithm”, Journal of the Royal Statistical Society, 39(1)) and are typically derived from the training audio data or may for example be given by a parameter known to the system and/or provided by a third party.

When more than one Gaussian, for example, 2, 3, 4 or more Gaussians are to be described, for example, in a Gaussian mixture model, a mean vector and covariance matrix are required for each Gaussian. In addition, the a priori probabilities of the components (the Gaussians) are also required. These are usually written as w_{spoof,1, w}_{spoof,2}. . . (w_{spoof},c_{spoof}, with c_{spoof}∈[1,C_{spoof}]) and/or w_{non-spoof,1}, w_{non-spoof,2}, . . . (w_{non-spoof,c}_{non-spoof}, with c_{non-spoof}∈[1,C_{non-spoof}]) for each Gaussian component c. The parameters are typically estimated by a suitable algorithm, e.g. by an EM and are typically derived from the training audio data or may for example be given by a parameter known to the system or provided by a third party.

In the particular case where C_{non-spoof}=1 and/or C_{spoof}=1, the a priori probability/a priori probabilities may be any positive value, e.g. be 1.

The training audio data used for deriving the parameters for the Gaussian classifier are usually chosen depending on the information that the Gaussian classifier should model. In the training data usually audio data is comprised for any kind of spoof which the classifier should recognize. Additionally, depending on the nature of the genuine (non-spoof) data expected to be used in the speaker recognition system, genuine audio data may also be present.

For example, when using a system according to the invention in combination with a text-dependent speaker recognition system working with a certain passphrase and/or a certain device and/or a certain kind of speaker, the training data should be recorded with the certain passphrase and/or the certain device and/or a certain speaker (e.g. speakers of the particular language that will be used in the speaker recognition system for which it is to be classified whether the received audio data is genuine or a spoof).

A system according to the invention may in particular be adapted for use with far-field attacks, (which may optionally be inserted directly into the speaker recognition system), and/or replay attacks.

Spoof data may also be available and may be used to derive parameters for the Gaussian classifier. Preferably, spoof data covers the most important or all of the spoof attacks to be expected or which should be classified as spoof by the system, for example, recording, e.g. far-field recording, and/or replay attacks, etc.

A system according to the invention may thus take advantage of the parameters that are present in the training data, for example, a passphrase and/or the device and/or the certain speakers and/or the spoof variability because the parameters of the Gaussian classifier are determined based on training audio data describing these features.

For example, there are embodiments where the non-spoof region of parameters is described by a Gaussian and the spoof region of parameters is described by a Gaussian. Usually, these Gaussians are described over a space having as many dimensions as parameters of the audio data are considered for classifying whether audio data is spoof or genuine.

In embodiments where the non-spoof region of parameters is described by one Gaussian and the spoof region of parameters is described by one Gaussian, mean vector μ_{spoof,1} of the spoof distribution and mean vector μ_{non-spoof,1} of the non-spoof distribution and covariance matrix Σ_{non-spoof,1} of the non-spoof distribution and covariance matrix of the spoof distribution Σ_{spoof,1} may each be determined or given as starting parameters for the Gaussians. In said example, the prior distributions may be defined as:

y|non-spoof˜N(y;μ_{non-spoof,1},Σ_{non-spoof,1}) (13)

y|spoof˜N(y;μ_{non-spoof,1},Σ_{non-spoof,1}) (14).

Herein, y represents the parameters considered in an audio data. For an embodiment

$$y = ( \begin{matrix}Δ \\ SR\end{matrix} )$$

where the two parameters are a feature vector distance and a spectral ratio (according to (8)). In other embodiments, y may represent the parameters MF and LF-MFCCₒ (according to (12)), and in further embodiments, y may represent or comprise a combination of any of the above-mentioned parameters feature vector distance, spectral ratio, MF and/or LF-MFCCₒ.

There are also embodiments where the non-spoof region of parameters and/or the spoof region of parameters are described by more than one Gaussian, e.g. one GMM composed by 2, 3 or more components c. In such cases, for each GMM, a mean vector value, a covariance matrix and an a priori probability are determined or given per component (Gaussian). In said example, the prior distributions may be defined as:

$$\begin{matrix}y \vert non - spoof ∼ {\sum }_{{c}_{non - spoof} = 1}^{{C}_{non - spoof}} {W}_{non - spoof , {c}_{non - spoof}} N ( y ; {μ}_{non - spoof , {c}_{non - spoof}} , {\sum }_{non - spoof , {c}_{non - spoof}} ) & ( 15 ) \\ y \vert spoof ∼ {\sum }_{{c}_{spoof} = 1}^{{C}_{spoof}} {W}_{spoof , {c}_{spoof}} N ( y ; {μ}_{spoof , {c}_{spoof}} , {\sum }_{spoof , {c}_{spoof}} ) & ( 16 )\end{matrix}$$

Alternatively, the space of the vector representing the parameters of the audio data, e.g. the space in which y lies (e.g. the space composed by MF and LF_MFCCₒ) may be modeled using a certain number C of full-covariance Gaussians (GMM) for spoof and non-spoof data. C_{spoof} may be the same as or different than C_{non-spoof}. Alternatively or additionally, diagonal matrices may be used for one or more or all of the covariance matrices describing the spoof and/or non-spoof data, wherein the following prior distribution of equations (15) and/or (16) may be used as starting point.

The parameters in (15) and (16) may e.g. be estimated with (prior) data and a suitable algorithm e.g. Expectation Maximization (EM) algorithm, e.g. as described above or similar thereto.

The data used to extract prior distributions may, in some embodiments, depend on the information that is to be modeled e.g. as described previously or e.g. taking into consideration the nature of the spoof and non-spoof data (sort of speakers, passphrases, recording devices . . . ). For example, for a text-dependent Speaker Recognition system which works with a certain passphrase (“Hello world”, for example), device (Iphone 4S, for example) and kind of speakers, (British ones for example), all the required data (spoof and/or non-spoof) may be recorded with the corresponding circumstances e.g. a British speaker saying “Hello world” with an Iphone 4S. Typically, it is advantageous to match the use case and the data to extract the prior distribution.

Thus, in some embodiments, it may be advantageous to use appropriate circumstances, e.g. for extracting prior distributions, e.g. of the passphrase, device and/or speaker for spoof and/or non-spoof.

Given such a model (e.g. one of the ones described above) with initial parameters, wherein a model with initial parameters may comprise a model wherein the initial parameters have been determined as described above, but also a model comprising parameters found in a different way (e.g. a model provided by a third party or a model which has been adapted previously), it may be (further) adapted by adaptation of the previous parameters of the Gaussian classifier using labeled adaptation audio data. This may be advantageous, if, for example, the adaptation audio data, typically adaptation audio data files, describe certain types of situations, for example, certain spoof attacks and/or genuine audio data which is not or not adequately described by the previously used classifier. Usually, the adaptation audio data is chosen depending on the information that the Gaussian classifier should model.

Such an adaptation may be done using a suitable algorithm, for example, using a maximum a posteriori (MAP) algorithm (as disclosed in e.g. J. Gauvin and C. Lee “Maximum Posteriori Estimation for Multivariate Gaussian Mixture Observations of Markov Chains” IEEE Transactions on Speech and Audio Processing, 2(2): 291-298). In particular, for example, the mean vector of the

1, 2, 3, 4, or more Gaussians representing the genuine audio data may be adapted as:

$$\begin{matrix}{μ}_{new , non - spoof , {c}_{non - spoof}} = {μ}_{initial , non - spoof , {c}_{non - spoof}} {α}_{ns} + ( 1 - {α}_{ns} ) \cdot \frac{{\sum }_{i = 1}^{{N}_{ns}} {γ}_{non - spoof , {c}_{non - spoof}} ( i ) {y}_{non - spoof , i}}{{\sum }_{i = 1}^{{N}_{ns}} {γ}_{non - spoof , {c}_{non - spoof}} ( i )} & ( 17 ) \\ {γ}_{non - spoof , {c}_{non - spoof}} ( i ) = \frac{\begin{matrix}{w}_{initial , non - spoof , {c}_{non - spoof}} N \\ ( {y}_{non - spoof , i} ; {μ}_{initial , non - spoof , {c}_{non - spoof}} , {\sum }_{initial , non - spoof , {c}_{non - spoof}} )\end{matrix}}{\begin{matrix}{\sum }_{{c}_{non - spoof} = 1}^{{C}_{non - spoof}} {w}_{initial , non - spoof , {c}_{non - spoof}} N \\ ( {y}_{non - spoof , i} ; {μ}_{initial , non - spoof , {c}_{non - spoof}} , {\sum }_{initial , non - spoof , {c}_{non - spoof}} )\end{matrix}} & ( 17.1 )\end{matrix}$$

Additionally or alternatively, the mean vectors of the 1, 2, 3, 4, or more Gaussians representing the spoof region of audio data parameters may be adapted as:

$$\begin{matrix}{μ}_{new , spoof , {c}_{spoof}} = {μ}_{initial , spoof , {c}_{spoof}} {α}_{s} + ( 1 - {α}_{s} ) \cdot \frac{{\sum }_{i = 1}^{{N}_{s}} {γ}_{spoof , {c}_{spoof}} ( i ) {y}_{spoof , i}}{{\sum }_{i = 1}^{{N}_{s}} {γ}_{spoof , {c}_{spoof}} ( i )} & ( 18 ) \\ {γ}_{spoof , {c}_{spoof}} ( i ) = \frac{\begin{matrix}{w}_{initial , spoof , {c}_{spoof}} N \\ ( {y}_{spoof , i} ; {μ}_{initial , spoof , {c}_{spoof}} , {\sum }_{initial , spoof , {c}_{spoof}} )\end{matrix}}{\begin{matrix}{\sum }_{{c}_{spoof} = 1}^{{C}_{spoof}} {w}_{initial , spoof , {c}_{spoof}} N \\ ( {y}_{spoof , i} ; {μ}_{initial , spoof , {c}_{spoof}} , {\sum }_{initial , spoof , {c}_{spoof}} )\end{matrix}} & ( 18.1 )\end{matrix}$$

Additionally or alternatively, the covariance matrices of the 1, 2, 3, 4, or more Gaussians representing the genuine region of audio data parameters and/or the 1, 2, 3, 4 or more covariance matrices representing the spoof region of audio data parameters may be adapted by:

$$\begin{matrix}{\sum }_{new , non - spoof , {c}_{non - spoof}} = {\sum }_{initial , non - spoof , {c}_{non - spoof}} {α}_{ns} + ( 1 - {α}_{ns} ) \cdot \frac{{\sum }_{i = 1}^{{N}_{ns}} {γ}_{non - spoof , {c}_{non - spoof}} ( i ) {( {y}_{non - spoof , i} - {μ}_{non - spoof , \sum } )}^{2}}{{\sum }_{i = 1}^{{N}_{ns}} {γ}_{non - spoof , {c}_{non - spoof}} ( i )} & ( 19 ) \\ {μ}_{non - spoof , \sum } = \frac{{\sum }_{i = 1}^{{N}_{ns}} {γ}_{non - spoof , {c}_{non - spoof}} ( i ) {y}_{non - spoof , i}}{{\sum }_{i = 1}^{{N}_{ns}} {γ}_{non - spoof , {c}_{non - spoof}} ( i )} & ( 19.1 ) \\ {\sum }_{new , spoof , {c}_{spoof}} = {\sum }_{initial , spoof , {c}_{spoof}} {α}_{s} + ( 1 - {α}_{s} ) \cdot \frac{{\sum }_{i = 1}^{{N}_{s}} {γ}_{spoof , {c}_{spoof}} ( i ) {( {y}_{spoof , i} - {μ}_{spoof , \sum } )}^{2}}{{\sum }_{i = 1}^{{N}_{s}} {γ}_{spoof , {c}_{spoof}} ( i )} & ( 20 ) \\ {μ}_{spoof , \sum } = \frac{{\sum }_{i = 1}^{{N}_{s}} {γ}_{spoof , {c}_{spoof}} ( i ) {y}_{spoof , i}}{{\sum }_{i = 1}^{{N}_{s}} {γ}_{spoof , {c}_{spoof}} ( i )} & ( 20.1 )\end{matrix}$$

Herein, μ_{initial,non-spoof},c_{non-spoof}, μ_{initial,spoof},c_{spoof}, Σ_{initial,spoof},c_{spoof},Σ_{initial,non-spoof},c_{non-spoof} are the parameters of the initial models for component c_{non-spoof} and c_{non-spoof} and c_{spoof} and γ_{non-spoof},c_{non-spoof} (i) and γ_{spoof},c_{spoof} (i) are the posterior probability of the initial c_{non-spoof} and c_{spoof} component of non-spoof and spoof models, given y_{non-spoof,i} and y_{spoof,i}, respectively (adaptation data). In a system according to the invention, the a priori probabilities of the components w_{initial,spoof},c_{spoof} and/or w_{initial,non-spoof},c_{non-spoof} may be adapted or may not be adapted.

The adaptation of one or more or all of the w_{initial,spoof},c_{spoof} and/or w_{initial,non-spoof},c_{non-spoof} may not be necessary because no relevant improvements with regard to adaptation of the other components may be given by such an adaptation. In other embodiments, some or all of these a priori probabilities of the components may be adapted.

N_{ns and N}ₛ are the numbers of the non-spoof and spoof audios used to adapt the initial models, which are represented by y_{non-spoof,i} and y_{spoof,i}, respectively (i index corresponds to the i-th audio data file). C_{non-spoof-} and C_{spoof} are the number of components of non-spoof and spoof GMMs. Finally, αₙₛ and αₛ are the weighing values for non-spoof and spoof adaptation, which are configuration variables that may e.g. be computed as:

$$\begin{matrix}{α}_{ns} = \frac{τ}{τ + {N}_{ns}} & ( 21 ) \\ {a}_{s} = \frac{τ}{τ + {N}_{s}} . & ( 22 )\end{matrix}$$

τ is the memory term that may be defined as a certain number, e.g. may be defined to be 2, 3, 4 or more, for example.

In a system according to the invention, the number of available samples of adaptation audio data may be considered in the adaptation process, e.g. as indicated in equations (21) and/or (22), which may be used in one or more of equations (17), (18), (19) and/or (20) and/or (25) and/or (26). In some embodiments of the system according to the invention, new parameters for the Gaussian classifier are found by adaptation of initial (previous) parameters of the Gaussian classifier using adaptation data which only comprises genuine audio data, usually several genuine audio data files. Then, instead of equation (18), the mean vectors of the 1, 2, 3, 4, or more Gaussians representing the spoof region of audio data parameters may be calculated as:

$${μ}_{new , spoof , {c}_{spoof}} = {μ}_{initial , spoof , {c}_{spoof}} + {\sum }_{{c}_{non - spoof} = 1}^{{C}_{non - spoof}} {w}_{initial , non - spoof , {c}_{non - spoof}} ( {μ}_{new , non - spoof , {c}_{non - spoof}} - {μ}_{initial , non - spoof , {c}_{non - spoof}} ) \qquad ( 23 )$$

instead of using equation (18). In such a situation, the spoof covariance matrices are usually not adapted. In some embodiments, however, the spoof covariance matrices may be adapted, for example according to (20) or (25).

In some embodiments of the system according to the invention, new parameters for the Gaussian classifier are found by adaptation of initial (previous) parameters of the Gaussian classifier using adaptation data which only comprises spoof audio data, usually several spoof audio data files. Then, instead of equation (17), the mean vectors of the 1, 2, 3, 4, or more Gaussians representing the genuine region of audio data parameters may be calculated as:

$${μ}_{new , non - spoof , {c}_{non - spoof}} = {μ}_{initial , non - spoof , {c}_{non - spoof}} + {\sum }_{{c}_{spoof} = 1}^{{C}_{spoof}} {w}_{initial , spoof , {c}_{spoof}} ( {μ}_{new , spoof , {c}_{spoof}} - {μ}_{initial , spoof , {c}_{spoof}} ) \qquad ( 24 )$$

instead of using equation (17). In such a situation, the non-spoof covariance matrices are usually not adapted. In some embodiments, however, the non-spoof covariance matrices may be adapted, for example according to (19) or (26).

A system according to the invention may also be adapted if no separate adaptation audio data is present. In such a case, the enrollment audio data may be considered to comprise the adaptation audio data. In such a case, adaptation may be done using a leave-one-out technique. Such a leave-one-out technique may in particular be relevant when the feature vector distance is one of the parameters to be adapted, and in some embodiment leave-one-out technique may only be used for adaptation of the feature vector distance.

This may e.g. be done by taking into consideration all enrolment data files which are present except one which is under consideration to extract the feature vector distance for the audio data file under consideration. When doing that for each of the enrolment audio data files, for each enrolment audio data file, a vector with the considered parameters of the audio data may be extracted, e.g. a two dimensional vector describing the spectral ratio and a feature vector distance. In some embodiments, such a leave-one-out technique is not used for all enrolment data files, but only for some which describe certain situations of interest. Using enrolment data for adaptation may imply having a spoof model and a non-spoof model for each enrolled speaker.

Afterwards, the mean vectors may be adapted, e.g. using equation (17) and (18) or equation (17) and (23), while the covariance matrices may not be altered. In other embodiments, additionally to the mean vectors, the non-spoof covariance(s) may be adapted using equation (19) or (26). In some embodiments, enrolment data may consist of or comprise non-spoof audio data (e.g. audio files). In that case, equations (17) and (23) may be used to adapt the mean values for spoof and non-spoof mean values and optionally, the non-spoof covariance may be adapted according to (19) or (26). In other embodiments, the enrollment may comprise spoof data in addition to or alternatively to genuine (non-spoof) audio data, and equations (18), (24) and/or (20) and/or (25) may be used for adaptation in addition or alternatively to (17), (19) and/or (26).

In other embodiments in the system according to the invention, model adaptation may not be used, e.g. because it may not be necessary. This may for example be the case if there is no adaptation data present that properly describes the situations to be considered. If that is the case, an adaptation may be disadvantageous.

In other embodiments of the invention, given such a model with initial parameters, wherein a model with initial parameters may comprise a model wherein the initial parameters have been determined as described above, but also a model comprising parameters found in a different way (e.g. a model provided by a third party or a model which has been adapted previously), it may be (further) adapted by adaptation of the previous parameters of the Gaussian classifier, e.g. if additional data for adaptation is available. This may for example be done using a suitable algorithm, e.g. a MAP algorithm, for example as described in the following.

Given an initial model for spoof and/or non-spoof data (e.g., the prior one), it can be adapted if some data are available, using Maximum A Posteriori, MAP, algorithm.

For example, the mean vector of the 1, 2, 3, 4 or more Gaussians representing non-spoof audio data may be adapted in accordance with equation (17), and/or the mean vector of the 1, 2, 3, 4 or more Gaussians representing spoof audio data may be adapted in accordance with equation (18).

Additionally, the covariance matrices of the 1, 2, 3, 4 or more Gaussians representing the spoof data (or only part of the covariance matrices of the 1, 2, 3, 4 or more Gaussians representing the spoof data) may in some embodiments be adapted using the following equation:

$$\begin{matrix}{\sum }_{new , spoof , {c}_{spoof}} = {\sum }_{initial , spoof , {c}_{spoof}} \cdot {α}_{s} + ( 1 - {α}_{s} ) \cdot [ \frac{1}{{\sum }_{i = 1}^{{N}_{s}} {γ}_{spoof , {c}_{spoof}} ( i )} {\sum }_{i = 1}^{{N}_{s}} {γ}_{spoof , {c}_{spoof}} ( i ) {( {y}_{spoof , i} - {μ}_{spoof , {c}_{spoof}} )}^{2} + {μ}_{initial , spoof , {c}_{spoof}}^{2} ] - {μ}_{new , spoof , {c}_{spoof}}^{2} & ( 25 ) \\ Herein , {μ}_{spoof , {c}_{spoof}} = \frac{{\sum }_{i = 1}^{{N}_{s}} {γ}_{spoof , {c}_{spoof}} ( i ) {y}_{spoof , i}}{{\sum }_{i = 1}^{{N}_{s}} {γ}_{spoof , {c}_{spoof}} ( i )} & ( 25.1 )\end{matrix}$$

Additionally or alternatively, the covariance matrices of the 1, 2, 3, 4 or more Gaussians representing the non-spoof data (or only part of the covariance matrices of the 1, 2, 3, 4 or more Gaussians representing the non-spoof data) may in some embodiments be adapted using the following equation:

$$\begin{matrix}{\sum }_{new , non - spoof , {c}_{non - spoof}} = {\sum }_{initial , non - spoof , {c}_{non - spoof}} \cdot {α}_{n s} + ( 1 - {α}_{n s} ) \cdot [ \frac{1}{{\sum }_{i = 1}^{{N}_{ns}} {γ}_{non - spoof , {c}_{non - spoof}} ( i )} {\sum }_{i = 1}^{{N}_{ns}} {γ}_{non - spoof , {c}_{non - spoof}} ( i ) \cdot {( {y}_{non - spoof , i} - {μ}_{non - spoof , {c}_{non - spoof}} )}^{2} + {μ}_{initial , non - spoof , {c}_{non - spoof}}^{2} ] - {μ}_{new , non - spoof , {c}_{non - spoof}}^{2} & ( 26 ) \\ Herein , \\ {μ}_{non - spoof , {c}_{non - spoof}} = \frac{{\sum }_{i = 1}^{{N}_{ns}} {γ}_{non - spoof , {c}_{non - spoof}} ( i ) \cdot {y}_{non - spoof , i}}{{\sum }_{i = 1}^{{N}_{ns}} {γ}_{non - spoof , {c}_{non - spoof}} ( i )} & ( 26.1 )\end{matrix}$$

Herein, the variables typically correspond to the variables which have been introduced previously (e.g. i refers to the number of audio data files used for adaptation . . . ).

Covariance matrices may in some embodiments be adapted using a suitable algorithm, e.g. MAP algorithm, as (25) and/or (26); however, in other embodiments this may not be done or may not be possible due to the reduced size of the adaptation data. For example, in those circumstances, the covariance matrices may not be adapted. Initial models for spoof and/or non-spoof data may e.g. be the prior ones, but may alternatively also be others obtained after a previous adaptation. Typically, some prior distributions are needed.

Another limitation may be the spoof data availability. In some cases, it is not possible to have representative spoof data, and the model adaptation must be carried out only with non-spoof data. Then, equation (18) may be replaced by equation (23) and the spoof covariance matrix would typically not be adapted (but may be adapted in some embodiments).

In other embodiments, only spoof data may be available, and some model adaptation may be carried out with spoof data only, e.g. by replacing equation (17) with (24). Also in that case, the spoof covariance matrix would typically not be adapted (but may be adapted in some embodiments).

The nature of the adaptation data may be chosen to match with the use case conditions (e.g. loudspeaker typically used for spoof in replay attacks, passphrase, device, speaker and/or other conditions). The nature of the adaptation data is typically chosen to match with the use case conditions in terms of passphrase, device, speaker and/or spoof. Then, variability of those variables can be taken into account.

In other embodiments under some circumstances, adaptation data may not be available. Then, model adaptation may be completed just with enrollment data, e.g. using the above mentioned equation(s) with or without adaptation of the covariance matrices. In other embodiments, such an approach may (only) provide a speaker model adapted non spoof model.

Typically, the model adaptation data may depend on the aspects that classifier should be adapted to in terms of speakers, passphrases, and/or recording devices and/or loudspeakers (e.g. the ones typically used in replay attacks) . . . For example, if the initial model is adapted to a given device, speaker and passphrase, some audios of the speaker, saying the required passphrase and recorded with the corresponding device would typically be used.

In other embodiments, model adaptation may not be necessary. It may, for example, not be necessary when the adaptation data does not match properly with the case for which it is intended to be used. Under those circumstances, an adaptation may be disadvantageous and worsen the results with regard to an initial model. In many such embodiments, no adaptation may be used.

Given a system according to the invention with initial or adapted parameters for the Gaussian classifier, audio data received in a speaker recognition system may be classified by extracting the parameters of the received audio data considered in a system according to the invention and evaluating the likelihood for the 1, 2, 3, 4, or more Gaussians modeling the genuine region of audio data parameters and/or the 1, 2, 3, 4, or more Gaussians modeling the spoof-region of audio data parameters.

If the likelihood that the parameters y of the audio data are in the spoof-region of parameters describing audio data from the posterior distribution is larger than k times the likelihood that the parameters y of the audio data are in the non-spoof region of parameters describing audio data from the posterior distribution, the audio data under consideration is considered spoof. Herein, k is a compensation term being determined based e.g. on the prior probabilities of spoof and nonspoof, the relative costs of classification error, and/or other considerations. This may e.g. be written as:

$${\sum }_{{c}_{spoof} = 1}^{{C}_{spoof}} {w}_{new , spoof , {c}_{spoof}} N ( y ; {μ}_{new , spoof , {c}_{spoof}} , {\sum }_{new , spoof , {c}_{spoof}} ) > k {\sum }_{{c}_{non - spoof} = 1}^{{C}_{non - spoof}} {w}_{new , non - spoof , {c}_{non - spoof}} N ( y ; {μ}_{new , non - spoof} , {\sum }_{new , non - spoof , {c}_{non - spoof}} ) ⇒ spoof . \qquad ( 27 )$$

Otherwise, the audio data may be classified as genuine (non-spoof). If a spoof model (Gaussian(s) describing spoof audio data) is not available, the decision could be taken as:

$$\frac{1}{k} > {\sum }_{{c}_{non - spoof} = 1}^{{C}_{non - spoof}} {w}_{new , non - spoof , {c}_{non - spoof}} N ( y ; {μ}_{new , non - spoof} , {\sum }_{new , non - spoof , {c}_{non - spoof}} ) ⇒ spoof \qquad ( 28 )$$

Otherwise, the audio data may be classified as genuine (non-spoof).

In other embodiments, if a genuine model (Gaussian(s) describing genuine audio data) is not available, and only a spoof model is available, the decision could be taken as:

$${\sum }_{{c}_{spoof} = 1}^{{C}_{spoof}} {w}_{new , spoof , {c}_{spoof}} N ( y ; {μ}_{new , spoof , {c}_{spoof}} , {\sum }_{new , spoof , {c}_{spoof}} ) > k ⇒ spoof \qquad ( 29 )$$

For example, in a system where the Gaussian classifier has been adapted using a lot of genuine audio data, k may be chosen higher than in a situation where the Gaussian classifier has not been adapted or where there are concerns that it may not be adapted to the current situation. Typically, k may be based on the prior probabilities of spoof and non-spoof and /or relative costs of classification error. k may for example be dependent on the number of audios used for adaptation of the model or other parameters. For example, k may be higher if a lot of non-spoof data was available for the adaptation of the model.

For example, k may be set to a number higher than 0, for example, it may be set to 0.1, 0.2, 0.5 or 0.8 or to 1, 2, 3, 4, or more. k is usually not lower than 0 because in such a case, a system may be partial to classify the audio data as spoof.

The invention also comprises a method for classifying whether audio data received in a speaker recognition system is genuine or a spoof using a Gaussian classifier. In particular, said method may comprise each of the steps which may be carried out in a previously described system.

Herein, w_{new,spoof},c_{_{spoof}} may be equal to w_{initial,spoof},c_{_{spoof}} for one or more or all c_{spoof} and/or

w_{new,non-spoof},c_{_{non-spoof}} may be equal to initial w_{initial,non-spoof},c_{_{non-spoof}} for one or more or all c_{non-spoof}. In other

embodiments, one, two, three or more or all of the w_{new,(non)-spoof},c_{_{(non)-spoof}} may be adapted value(s) with regard to the initial a priori probability/probabilities.

The invention further comprises a computer-readable medium comprising computer-readable instructions that, when executed on a computer, are adapted to carry out a method according to the invention.

Each following figure shows certain steps of a session in which the identity of a speaker is verified.

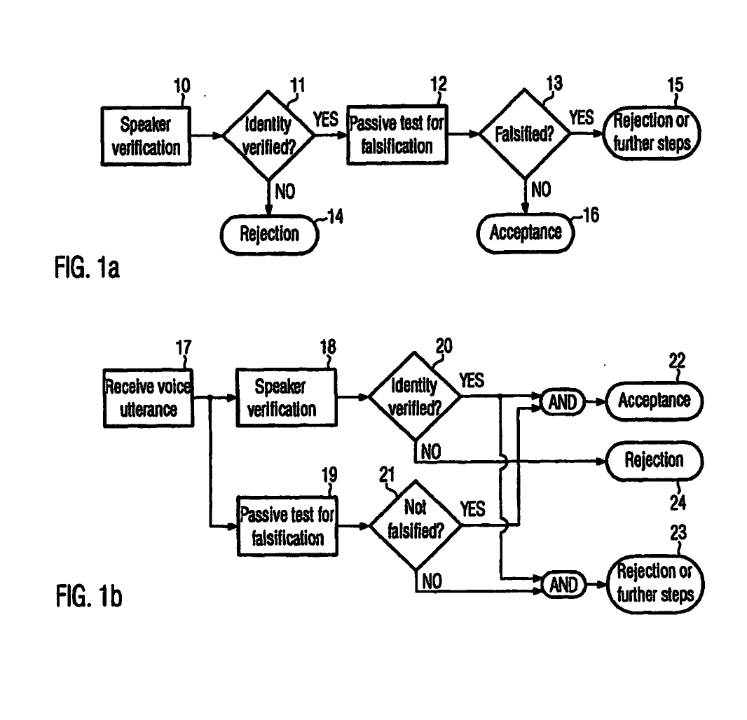

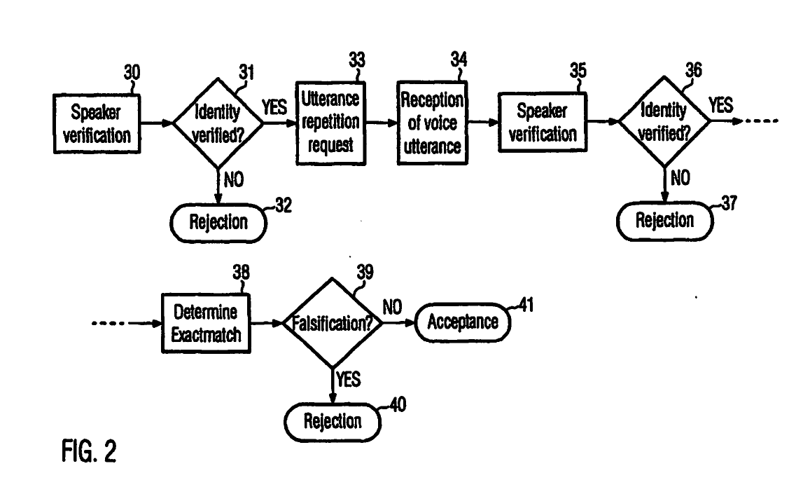

In FIG. 1a, in item 10, speaker verification is performed. In this step, a voice utterance has just been received in the same session and biometric voice data (such as a GMM or a HMM) is used to verify that this speaker's voice corresponds to the speaker, the identity of which is to be verified. Speaker verification may be based on data (such as a voice model) which is stored in a database, and which are extracted from voice utterances from speakers during a registration or training phase.

During speaker verification a particular speaker is verified, which means that an identity is assumed and this identity needs to be verified. With the identity information at hand, which can be based, e.g., on a speaker name, a telephone number of an incoming telephone call or the like, the particular biometric voice data is retrieved from a database and is used in processing a received voice utterance in order to verify that the speaker's voice corresponds to the speaker the identity of which is to be verified.

The result of the speaker verification leads to a logical result which is positive or negative (yes/no) and indicates whether or not the identity is verified. This is shown in step 11 in FIG. 1a. If the identity is not verified, the speaker is rejected in item 14. If the identity can be verified, it has to be taken into account that the received voice utterance may be falsified, e.g., recorded beforehand. Therefore, in item 12 a passive test for falsification is preformed. A passive test is one which does not need any other voice utterance actively provided by the speaker at that time, but which relies only on the voice utterance received in this speaker verification step 10. Such passive test for falsification is, in particular, advantageous, since no further speaker input is required, which allows for a way to determine whether or not the received voice utterance may be falsified without, however, annoying speakers which are not intending fraud. Since, however, a speaker is accepted directly in case that the passive test 12 does not indicate any suspicion of falsification this passive test preferably is able to check multiple types of falsification. This test therefore may carry out a check for determination of a far field recording, anomalies in the prosody, presence of a watermark, discontinuities in the background, as explained above, or other kind of check. If any check indicates a falsification k will be concluded in step 13 that the voice utterance is falsified.

If no indications can be found that the voice utterance was falsified, the speaker is accepted (see item 16). If it was found out that the voice utterance was falsified, then the speaker may be rejected or further steps may be taken (see item 15). The particular type of action (rejection or further steps) may be made dependent on the kind of passive check that indicated that a voice utterance was falsified. Different checks may work with a different reliability concerning the detection of falsified voice utterances. If a check that is (very) reliable indicated falsification the user may be rejected directly. If a less reliable check indicates falsification further steps may be taken (as explained above or below such as an active test for falsification) in order to confirm of overrule the finding of a falsified voice utterance.

In FIG. 1b an alternative approach is shown in which speaker verification and a passive test for falsification (steps 18 and 19) are performed independently of each other and/or in parallel. Both steps rely on a voice utterance received in step 17, which means one and the same voice utterance. The speaker verification in item 18, and the passive test for falsification in item 19, each of which allows for a decision of whether or not the speaker shall be accepted are logically combined. If both tests result positive, the speaker is accepted (see item 22). If the verification step 20 is negative the speaker is rejected independent of the result of item 21 (see item 24). If in item 20 a positive result is obtained and in item 21 a negative the speaker may be rejected in item 23, or further steps may be taken in order to determine whether or not the speaker is to be accepted or rejected. The particular action taken in step 23 may be made dependent on the particular type of check that indicated falsification in step 19, 21 as explained above for step 15.

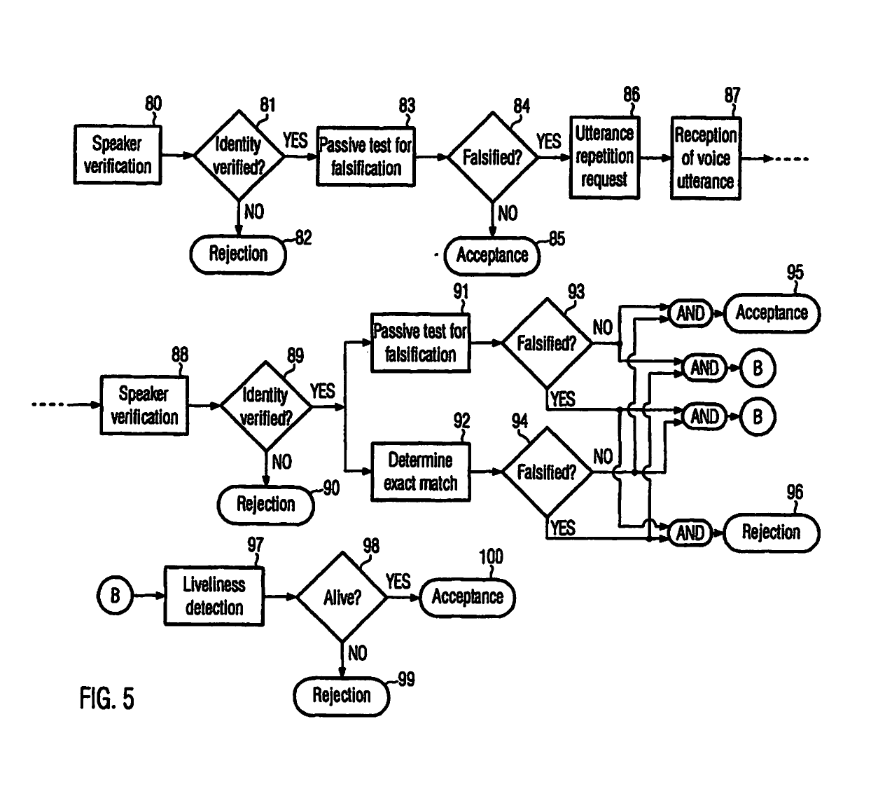

While in FIGS. 4, 5 and 6 the same initial scheme as that of steps 10 to 13 of FIG. 1 is shown those steps may be substituted by steps of FIG. 1b.

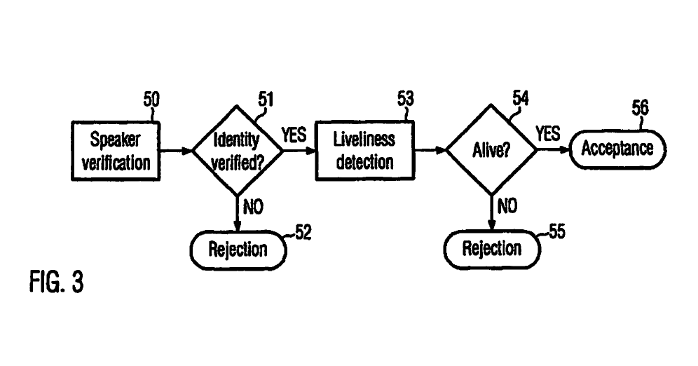

FIG. 2 shows a particular advantageous embodiment, wherein, after speaker verification in item 30 it is decided whether the identity is verified or not in item 31. If the identity is not verified, the speaker is rejected (item 32). If the identity is verified, then before accepting the speaker the speaker is requested to provide a further voice utterance in step 33, which is received in item 34. This voice utterance is again processed for speaker verification in item 35, and if in this step the speaker's identity cannot be verified, then the speaker is rejected in item 37. If the result of the test in item 36 is positive then it is proceeded to step 38 where it is checked whether or not the two voice utterances received in item 30 and 35 are having an exact match. If this is the case, then in item 39 it is determined that one or both voice utterances are falsified and, hence, the speaker is rejected in item 40. Otherwise he is accepted in item 41.

Such a procedure is more complicated for a speaker since he has to provide at least two voice utterances. It is, however, providing a good degree of certainty for the question of whether or not the voice utterance is falsified. This good degree of certainty comes in particular from the combination of the step of speaker verification of the second voice utterance with determination of an exact match since an attempt to pass by the exact match test by changing the second voice utterance may lead to a rejection by not passing the speaker verification test 35.

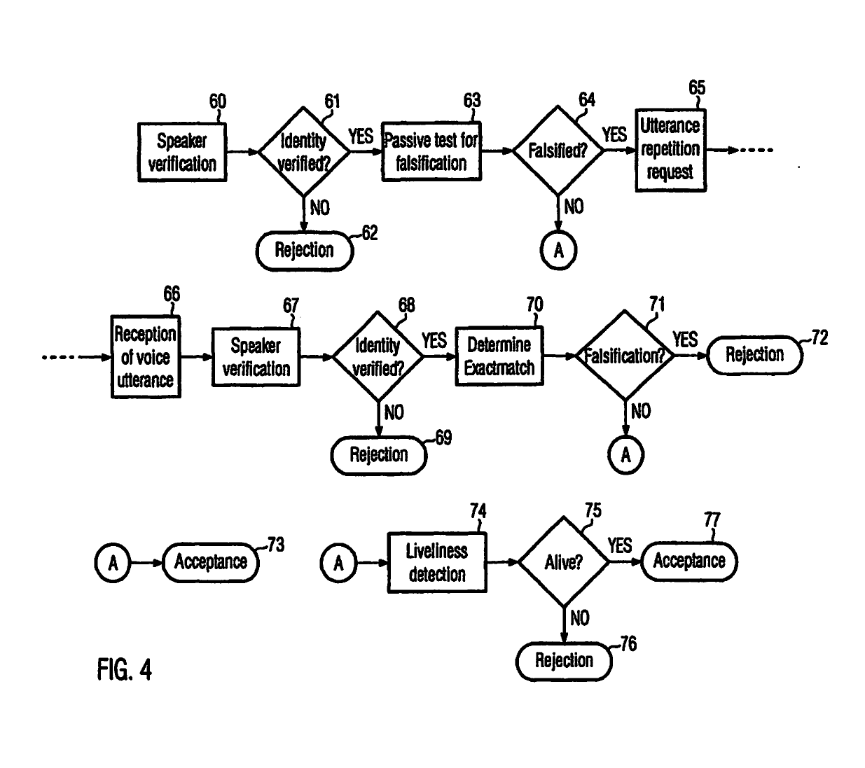

FIG. 3 shows another particular example, wherein, after speaker verification in items so and 51 which may lead to the rejection item 52 in item 53 a liveliness detection is performed. Here the liveliness detection is carried out directly after the step of the speaker verification such that no pre-steps are performed. Liveliness detection may be considered particularly annoying for speakers, since further input from the speaker is required which needs to be provided such that some kind of intelligence on the speaker's side can be detected. If in item 54 it is determined that the speaker is alive, he is accepted in item 56 and otherwise rejected in item 55.

In FIG. 4 an example is shown where active tests for falsification are performed after a passive test for falsification. This corresponds to the case where in FIG. 1 in item 15 further steps are taken. In FIG. 4 a speaker is verified in items 60 and 61, and rejected in item 62 in case that the identity cannot be verified. If the identity is verified, then the passive test for falsification is carried out in item 63. The result, thereof, is checked in item 64. If it is determined that the voice utterance was not falsified, then the method would proceed to item 73 (see encircled A). If it is found out that the voice utterance may be falsified, then the speaker is not directly rejected, but further steps are taken. In the particular example a further utterance is requested from the speaker in item 65 and received in item 66. This additionally received voice utterance is checked by the speaker verification step in 67. If the identity cannot be additionally verified from this voice utterance, the speaker is rejected in item 69, and otherwise it is proceeded to determine an exact match in item 70. If an exact match is found (see item 71), then the speaker is rejected in item 72, and otherwise it is proceeded to the acceptance 73. In FIG. 4 an alternative for the acceptance step 73 is shown, which indicates that before accepting a speaker a liveliness detection 74 may be carried out. In step 75 it is decided whether or not the speaker is considered to be alive, and then, if this test turns out positive, the speaker is accepted instep 77 and otherwise rejected instep 76.

The voice utterance received in item 66 may be checked for its semantic content. This means that it is checked, that the semantic content of the utterance received in item 66 fits to the semantic content requested in item 65. This test may be done in item 66, 67 or 70. If the semantic content does not fit a speaker may be rejected or the method goes back to step 65 requesting again a voice utterance.

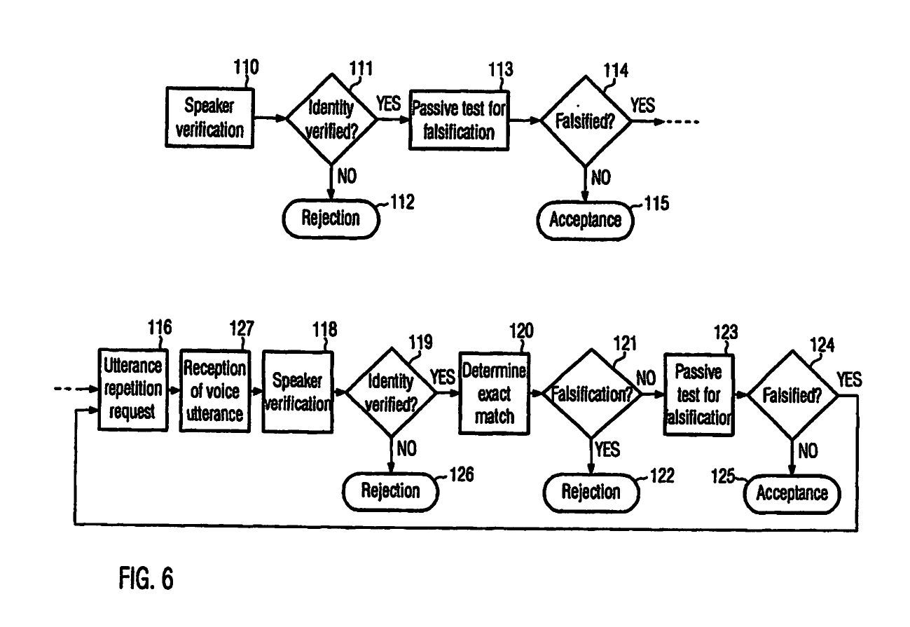

FIG. 5 shows a particular advantageous further example in terms of convenience for speakers and security concerning the identity verification.

In step 80 a speaker is verified based on a received voice utterance received in this step. If in step 81 the identity of the speaker is not verified the speaker is rejected in item 82. In case that the identity is verified first a passive test for falsification 83 is carried out. Since this passive test does not need any additional speaker input, it does not affect convenience of the system for a speaker who is not intending fraud. If in step 84 it is determined that the voice utterance is not falsified, the speaker is taken directly to acceptance 85. In such a case a speaker does not notice any change of the system with respect to introducing the verification step whether or not the received voice utterance is falsified. In case that in step 84 it is determined that the voice utterance is falsified or may be falsified the method proceeds to step 86 where a further utterance by the speaker is requested which is received in step 87. In step 88 this additionally received voice utterance is processed for speaker verification. If the identity of the speaker, which is to be verified, cannot be identified in step 89 the speaker is rejected in step 90.

If the identity can be positively verified, then the method proceeds to steps 91 and 92. Both steps can be carried out in parallel, they may, nevertheless, also be carried out one after the other. It is, however, preferable to carry out the two steps independently of each other, and/or in parallel since then the results of the two tests 91 and 92 can be evaluated in combination. This is shown in FIG. 5, where in steps 93 and 94 each two possible results are achieved, one being positive, and one being negative on the question of whether or not any voice utterance, in particular, the second voice utterance is falsified. If both tests determine that the voice utterance is not falsified, then it is proceeded to acceptance in item 95. In this case, it has to be assumed that the test in step 84 was erroneous.

By performing the passive test for falsification also on the second voice utterance in step 91 it is assured that any hint on falsification present only in the second voice utterance, which may be different from the kind of hint determined in the first voice utterance is identified and taken into account.

If both tests 93 and 94 give a negative result, then it is proceeded to rejection in item 96. In case that the test in step 93 and 94 give contradictory results, then the more profound test can be performed following the B in the circle. Here, additionally, a liveliness detection is performed in step 97, which then leads to the final rejection 99 or acceptance 100 based on the result in item 98.

This embodiment is convenient for a large amount of speakers who do not have any intensions of fraud and which are taken to acceptance 85. For those speakers who are, however, erroneously qualified as using falsified voice utterances in step 84, the group of tests 91 and 92 are carried out in order to be able to reverse the finding of step 84. If, however, no clear decision (acceptance 95 or rejection 96) can be made, then a more advanced test for liveliness detection can be carried out in order to achieve the final decision. In the embodiment of FIG. 5, three different tests or groups of tests (item 84, combined item 93, 94 and item 98) are cascaded in order to obtain a minimum number of false rejections and a high security to determine fraud, while at the same time offering a convenient approach to the majority of speakers.

In the embodiment of FIG. 5 the semantic content of the voice utterance received in item 87 can be checked to see whether or not it fits with the semantic content of the voice utterance requested in item 86. If the semantic content does not fit, the method may reject the speaker or go back to item 86, such that further voice utterance is received.

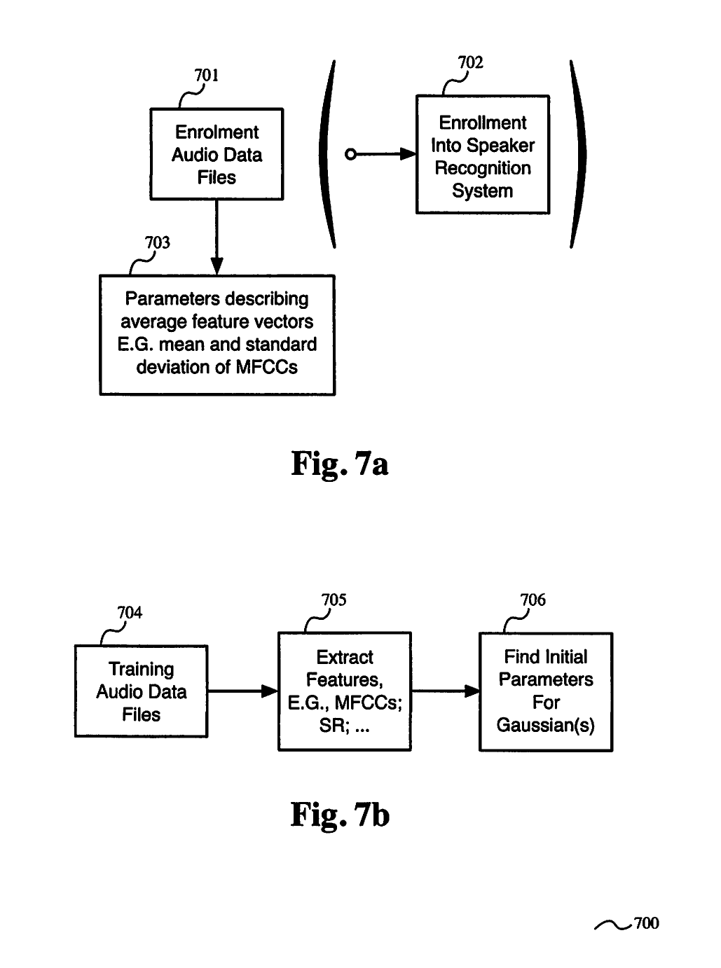

FIG. 6 shows another particular preferred example, which includes a loop in the method steps. Similarly to steps 80 to 89 steps 110 to 119 are performed. Then, however, a determination of an exact match in item 120 and the evaluation thereof with the possibility of rejection in item 122 is performed in step 121. Thereafter, a passive test for falsification in item 123 is carried out and evaluated in item 124 with the possibility of acceptance in 125. The combination of steps 120 and 121 with the combination of 123 and 124 can also be carried out in the reverse order with steps 123 and 124 performed beforehand. However, the determination of the exact match in item 120 is preferred to be carried out beforehand, such that in any case a rejection in item 122 can be performed in case that an exact match is determined.

If the test 123 gives a positive result concerning the question of falsification, then the method returns to step 116, wherein, a further utterance is requested.

This way a new voice utterance is received which can be checked as explained beforehand. In case that, for example, two different voice utterance recordings are used in a fraudulent way, then the first determination in item 120 may not indicate falsification in step 121. If then, however, a third voice utterance is received in the second passage of the loop, then the third voice utterance will be an exact match with the first or the second received voice utterance, which may then be determined in step 120. Therefore, in step 120 the determination of an exact match may be performed with respect to the lastly received voice utterance in step 116, with any other previously received voice utterance (in the same session), or the last two, or last three, or last four received voice utterances. In this way, in case that more than one recorded voice utterance is present the same may be used in order to determine an exact match in 120 and to identify falsification in step 121.

As can be seen from FIG. 6 the identification of an exact match leads to rejection. The passive test for falsification in step 123 does not lead directly to a rejection since such test has been found out to be less reliable. Therefore in order to avoid a false rejection the loop is provided, thereby increasing convenience for speakers, by giving them another chance.

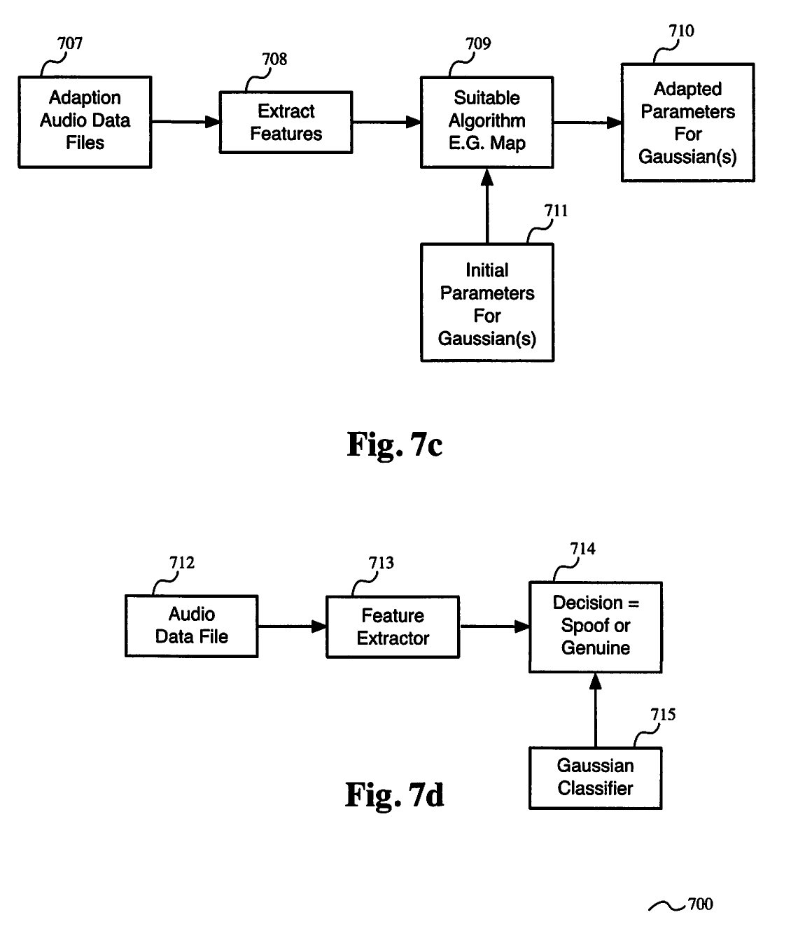

FIG. 7 shows steps for which a system according to the invention may be adapted.

FIG. 8 shows steps which may be used in feature extraction.

FIG. 7a shows a step which may be used in a method according to the invention. In particular, it shows that e.g. in an initial step 701, starting from enrollment audio data files, parameters describing average feature vectors may be found as shown in a substep 702, for example the mean and the standard deviation of MFCCs describing the enrollment audio data. The enrollment data files may e.g. have been used for the enrollment into the speaker recognition system, as shown in an optional substep 703. This is usually not done in a system according to the invention, but may be done in a system according to the invention in some embodiments.

In other embodiments, the average feature vectors, for example the mean and the standard deviation of MFCCs, are fixed or may also be provided by a third party.

In some embodiments of the invention, the parameters describing average feature vectors are used to calculate the distance of the parameters describing the received audio data thereof in later steps.

FIG. 7b shows a step where starting, in an initial step 704, from training audio data files which typically comprise genuine and/or spoof audio data, features are extracted, for example, the MFCCs and/or a spectral ratio, and/or other features describing the training audio data files in a next step 705. From these extracted features, the initial parameters for the Gaussian(s) of the Gaussian classifier may be found in a next step 706. For example, the mean, standard deviation and a priori probability per component considering the features, for example the spectral ratio and/or the feature vector distance may be found. The feature vector distance may e.g. be given by the (absolute value of the) distance of the mean MFCCs of the training audio data file to the mean of the MFCCs describing the enrollment audio data divided by the standard deviation of the MFCCs describing the enrollment audio data files. The reference for calculating the feature vector distance (mean of the MFCCs) may alternatively or additionally be provided by a third party and/or a given fixed value.

FIG. 7c shows how the parameters for the Gaussian(s) of the Gaussian classifier may be adapted. Starting out from adaptation audio data files in an initial step 707, features may be extracted in a next step 708. Considering the initial parameters for the Gaussian(s) and using a suitable algorithm in a next step 709, for example, MAP, the parameters for the Gaussian(s) may then be adapted in a next step 710. Herein, it is to be noted that the initial parameters 711 for the Gaussian(s) may be the initial parameters of the Gaussian found in FIG. 1b, but may also correspond to parameters provided by a third party, given by the system or parameters used in previous models which had already been adapted with regard to other initial parameters and/or other adaptation audio data. An adaptation may e.g. be done for any model that does not fit the situation under consideration properly.

In other embodiments, a system according to the invention does not carry out the steps of FIG. 7c because the initial parameters for the Gaussian(s) describe the situation as well as it is to be expected that an adapted model would, for example, if no suitable adaptation audio data is present.

FIG. 7d shows steps which may be carried out in a system according to the invention. In particular, starting from a received audio data file in an initial step 712, features are extracted in a next step 713. Then, in a next step 714, using the Gaussian classifier 715 and the features extracted from the audio data file in a previous step 713, a decision is rendered whether the audio data file under consideration is a spoof or genuine.

FIG. 8a shows steps which may be used for feature extraction, in this case in particular during calculation of a Medium Frequency Relative energy. In particular, an audio signal x(n) is used as input. Starting from audio signal x(n), the audio signal is filtered, for example with a band pass filter as indicated in an initial step 801, to extract the frequency components in the desired frequency band between a first frequency fₐ and a second frequency f_{b}, thus providing filtered signal y(n).

Both the initial audio x(n) and the filtered version y(n) may then be windowed in following steps 802, 804, for example using Hamming windows, thus generating xₜ(n) and yₜ(n) for the t-th frame.

Then in following steps 803, 805 a variable descriptive of the energy (or an energy) may be computed, for example as mentioned above the equations (9) and (10), thus generating eₓ(t) and e_{y}(t). Then, in a final step 806, the ratio of the energy terms may be computed, and averaged over all relevant frames, e.g. all speech frames or all frames with a certain energy or all frames, or frames chosen for other reasons, for example as indicated in equation (11), thus rendering the Medium Frequency Relative Energy (MF).

FIG. 8b shows steps which may be used for feature extraction, in this particular case for calculation (extraction) of LF-MFCCₒ.

Starting from an audio signal x(n), an optional filter is applied, which in this embodiment is shown as a low pass filter, rendering filtered signal y(n). Then, optional downsampling of the filtered signal y(n) is carried out rendering y_{d}(n).

An optional pre-emphasis filter, for example to flatten the speech signal spectrum compensating the inherent tilt due to the radiation phenomenon along with the glottal pulse spectral decay, may be carried out achieving a filtered signal z(n). Such a pre-emphasis filter may for example be a first order high pass band filter with a coefficient value ζ of approximately 0.87, for example between 0.85 and 0.89.

Optionally, windowing (e.g. Hamming windows) may then be applied to the z(n), generating zₜ(n).

After this optional windowing, a Fast Fourier Transformation may be carried out and the absolute value thereof may be computed, thus rendering Zₜ(k). In other embodiments, other solutions than FFT may be used to estimate (calculate) the spectrum.

Then, an optional spectral smoothing step may be carried out (e.g. with a frequency scale filter bank) which may for example be used to remove the harmonic structure of speech corresponding to pitch information and/or to reduce the variations of the spectral envelope estimation and/or to achieve a reduction in the number of parameters that could represent each frame spectrum.

This may for example be carried out by filter that operate in the frequency domain by computing a weighted average of the absolute magnitude of the estimation of the spectrum (e.g. FFT values) for each audio window Gₜ(m). After the filtering, the log of each coefficient may be taken.

12631 To this value, a discrete cosine transformation may be carried out to extract first the components LF-MFCC_{t,o}(r) from Gₜ(m). Then, LF-MFCCₒ may be extracted by averaging the selected coefficients of LF-MFCC_{t,o}(r) for all relevant frames, e.g. all speech frames, wherein speech frames may for example be defined as explained above, or all frames above a certain energy, or all frames chosen to another criterium.

What is claimed is:

1. A system for classifying whether audio data received in a speaker recognition system is genuine or a spoof using a Gaussian classifier.

2. The system of claim 1, wherein one, two, three, four or more Gaussians are used to model the genuine region of audio data parameters and/or wherein one, two, three, four or more Gaussians are used to model the spoof region of audio data parameters and/or wherein the system is adapted to be exclusively used to determine if received audio data is genuine or a spoof.

3. The system of claim 1, wherein the considered parameters of the audio data comprise a spectral ratio and/or a feature vector distance and/or a Medium Frequency Relative Energy (MF) and/or Low Frequency Mel Frequency Cepstral Coefficients (LF-MFCC) and/or wherein the feature vector distance is calculated with regard to average feature vectors derived from enrollment data used for enrollment of 1, 2, 3, or more speakers into the Speaker Recognition System and/or wherein the feature vector distance is calculated with regard to a constant value provided, e.g. by a third party or the system.

4. The system of claim 3, wherein the feature vector distance is calculated using Mel Frequency Cepstrum Coefficients.

5. The system of claim 3, wherein a Cauer approximation is used when extracting LF-MFCC and/or wherein a Cauer approximation is used when extracting MF and/or wherein Hamming windowing is used when extracting LF-MFCC and/or wherein Hamming windowing is used when extracting MF and/or wherein 1, 2, 3 or more or all LF-MFCC comprised in the parameters describing the audio data are selected, e.g. with develop data from known loudspeakers which may be used in replay attacks and/or with a priori knowledge and/or wherein when calculating 1, 2, 3 or more or all LF-MFCC comprised in the parameters describing the audio data, for the estimation of the spectrum autoregressive modelling and/or linear prediction analysis are used and/or wherein the filter for calculating MF is built to maintain certain relevant frequency components of the signal, which are optionally selected according to the spoof data which should be detected, e.g. according to the frequency characteristics of loudspeakers which are typically used for spoof in replay or other attacks.

6. The system of claim 1, wherein initial parameters for the Gaussian classifier are derived from training audio data using an Expectation Maximization algorithm, wherein optionally the training data is chosen depending on the information that the Gaussian classifier should model and/or wherein initial parameters for the Gaussian classifier are provided, e.g. by a third party or the system.

7. The system of claim 1, wherein new parameters for the Gaussian classifier are found by adaptation of previous parameters of the Gaussian classifier using adaptation audio data.

8. The system of claim 1, wherein the number of available samples of adaptation audio data is considered in the adaptation process.

9. The system of claim 1, wherein the mean vector(s) and/or the covariance matrices and/or the a priori probability of one, two, three, four or more Gaussians representing the genuine region of audio data parameters and/or wherein the mean vector(s) and/or the covariance matrices and/or the a priori probability of one, two, three, four or more Gaussians representing the spoof region of audio data parameters are adapted.

10. The system of claim 1, wherein the enrollment audio data comprises the adaptation audio data.

11. The system of claim 1, wherein the adaptation audio data comprises genuine audio data and/or spoof audio data.

12. The system of claim 1, wherein the adaptation audio data is chosen depending on the information that the Gaussian classifier should model.

13. The system of claim 1, wherein in classifying whether the received audio data is genuine or a spoof a compensation term depending on the particular application is used.

14. A method for verifying the identity of a speaker based on the speaker's voice, comprising the steps of:
receiving, at a computer, a voice utterance;
verifying, using the computer, that the speaker's voice corresponds to the speaker the identity of which is to be verified based on the received voice utterance, using biometric voice data;
verifying, using the computer, that the received voice utterance is not falsified after having verified the speaker's voice in a previous step and without requesting any additional voice utterance from the speaker, using one the following procedures:
determining a speech modulation index or a ratio between signal intensity in two different frequency bands, or both, of the received voice utterance preferably to determine a far field recording of a voice;
evaluating the prosody of the received voice utterance; and
detecting discontinuities in the background noise; and
accepting the speaker's identity to be verified when both verification steps give a positive result and not accepting the speaker's identity to be verified if any verification steps give a negative result.

15. The method of claim 14, further comprising the steps of:
requesting a second voice utterance and receiving a second voice utterance after step (c) of claim 1; and
processing the first received voice utterance and the second received voice utterance in order to determine an exact match between the two voice utterances.

16. The method of claim 15, wherein the second received voice utterance is used for verifying that the speaker's voice corresponds to the speaker the identity of which is to be verified, preferably before determining the exact match.

17. The method of claim 16, wherein the semantic content of the second received voice utterance or a portion thereof is identical to that of the first received voice utterance or a portion thereof.

18. The method of claim 17, wherein the first received voice utterance and the second received voice utterance are processed in order to determine an exact match and the second voice utterance is processed by a passive test for falsification without processing any other voice utterance or data determined thereof in order to verify that the second received voice utterance is not falsified, and wherein the two processing steps are carried out independently of each other and the results of the processing steps are logically combined in order to determine whether or not any voice utterance is falsified.

19. The method of claim 18, wherein a logical combination of results of the steps taken in step (c) to detect falsification of a voice utterance is used to decide whether or not to perform a liveliness test of the speaker and wherein preferably a liveliness test of the speaker is performed only when the two processing steps give contradictory results concerning the question whether or not at least the second voice utterance is falsified.

20. The method of claim 19, wherein verifying that the received voice utterance is not falsified further comprises determining liveliness of the speaker.

23. The method of claim 22, wherein liveliness is determined by the steps of:
selecting a sentence with a system having a pool of at least 100 stored sentences, wherein the sentence preferably is not a sentence used during a registration or training phase of the speaker;
requesting the speaker to speak the selected sentence;
receiving a further voice utterance;
using voice recognition means to determine that the semantic content of the further voice utterance corresponds to that of the selected sentence; and
using biometric voice data to verify that the speakers voice corresponds to the speaker the identity of which is to be verified based on the further voice utterance.

22. The method of claim 21, wherein the method performs one or more loops, wherein in each loop a further voice utterance is requested, received, and processed, wherein the processing of the further received voice utterance preferably comprises one or more of the following substeps:
using biometric voice data to verify that the speaker's voice corresponds to the identity of the speaker the identity of which is to be verified based on the received further voice utterance;
determining an exact match of the further received voice utterance with a previously received voice utterance;
determining a falsification of the further received voice utterance based on the further received voice utterance without processing any other voice utterance; and
determining liveliness of the speaker.

23. The method of claim 22, wherein the method provides a result that is indicative of the speaker's being accepted or rejected.

24. A computer having software stored and operable thereon that carries out the steps of the method of claim 14.
